(19) United States
(12) Patent Application Publication
(10) Pub. No.: US 2018/0348960 A1
(43) Pub. Date: Dec. 6, 2018

(54) INPUT DEVICE

(71) Applicant: OMRON Corporation, Kyoto (JP)

(72) Inventors: Masayuki Shinohara, Kyoto (JP); Yasuhiro Tanoue, Shiga (JP); Gouo Kurata, Hyogo (JP); Norikazu Kitamura, Osaka (JP); Yoshihiko Takagi, Kyoto (JP); Mitsuru Okuda, Aichi (JP); Yuto Mori, Kyoto (JP)

(73) Assignee: OMRON Corporation, Kyoto (JP)

(21) Appl. No.: 15/985,372

(22) Filed: May 21, 2018

(30) Foreign Application Priority Data
Jun. 6, 2017 (JP) 2017-111970

(51) Int. Cl. G06F 3/042; G01S 17/08; H04N 13/388; F21V 8/00

(52) U.S. Cl. CPC G06F 3/0421; G02B 6/005; H04N 13/388; G01S 17/08

(57) ABSTRACT

An input device recognizes that a user is placing a finger or another object toward an image formed in a space and notifies the user of the recognition. An input device includes a light guide plate that guides light received from a light source and emit the light through a light emission surface to form an image in a space, a position detection sensor that detects a pointer in a space including an imaging position at which the image is formed, and a notification controller that performs control to sense a user input in response to detection of the pointer by the position detection sensor and change a method of notification to the user in accordance with a distance between the imaging position and the pointer.

### FIELD

The present invention relates to an input device that forms an image in a space and senses a user input for the image.

### BACKGROUND

A known optical device forms an image in a space by emitting light from the light emission surface of a light guide plate and detects an object located near the emission surface of the light guide plate (Patent Literature 1). Another known optical device forms an image in a space and detects an object in a space, as described in Patent Literature 2 and Patent Literature 3. Such devices enable a user to perform an input operation by virtually touching a stereo image of a button appearing in the air.

### RELATED ART

### Patent Literature

Patent Literature 1: Japanese Unexamined Patent Application Publication No. 2016-130832

Patent Literature 2: Japanese Unexamined Patent Application Publication No. 2012-209076

Patent Literature 3: Japanese Unexamined Patent Application Publication No. 2014-67071

Patent Literature 4: Japanese Patent No. 5861797

Patent Literature 5: Japanese Unexamined Patent Application Publication No. 2009-217465

Patent Literature 6: Japanese Unexamined Patent Application Publication No. 2012-173872

### SUMMARY

For a button or another image projected in a space, a user trying to touch the projected image places his or her finger toward the image. Because the projected image is not physically touchable, the user may worry whether the input operation for the projected image is accurately sensed in the device.

One or more aspects of the present invention are directed to an input device that recognizes that a user is placing a finger or another object toward an image formed in a space and notifies the user of the recognition.

An input device according to one aspect of the present invention includes a first light guide plate that guides light received from a light source and emits the light through a light emission surface to form an image in a space, a sensor that detects an object in a space including an imaging position at which the image is formed, an input sensor that senses a user input in response to detection of the object by the sensor, and a notification controller that performs control to change a method of notification to the user in accordance with a distance between the imaging position and the object. The distance is detected by the sensor.

The above structure changes the method of notification to the user in accordance with the distance between the imaging position and the object and can thus notify the user that the input device is about to receive the input operation performed with the object. The user can learn that the input operation with the object is recognized by the input device. This eliminates the user's worry that the input device may not recognize the operation. In other words, the input device recognizes that the user is placing a finger or another object toward an image formed in a space and notifies the user of the recognition.

In the input device according to the above aspect, the notification controller may use a different method of notification for when the object is located in a nearby space that is a predetermined range from the imaging position and for when the object is located at the imaging position.

The above structure enables the user to confirm that the input device has received the operation on the input device performed with a pointer F. This eliminates the user's worry that the input device may not receive the input and provides the user with a sense of operation on the input device.

In the input device according to the above aspect, the image may include a plurality of images formed at a plurality of positions, and the nearby space may be defined at an imaging position of each of the plurality of images. When the object is detected in the nearby space, the notification controller may provide a notification identifying the image formed at the position included in the nearby space.

The above structure notifies the user of one of the multiple images for which the operation is about to be received by the input device. The user can thus confirm the image for which the operation is about to be received by the input device. This eliminates the user's worry that the input may be directed to an unintended image.

In the input device according to the above aspect, the notification controller may change a display state of the image to change the method of notification. In the above aspect, the user can learn that the input device has received or is about to receive the user operation by confirming the change in the display state of the image.

The input device according to the above aspect may further include a light controller located adjacent to the light emission surface of the first light guide plate or located opposite to the light emission surface. The light controller may change a light emission state or a light transmission state depending on a position. The image may include a plurality of images formed at a plurality of positions. The notification controller may change a light emission state or a light transmission state in the light controller depending on the imaging position of each of the plurality of images to change the method of notification.

The above structure can change the light mission state or the light transmission state depending on the imaging position of each of the images to allow the user to confirm the image for which the operation is about to be received or has been received by the input device.

In the input device according to the above aspect, the light controller may be any one selected from a light emitter that controls light emission of a plurality of light emitters arranged at a plurality of positions, a second light guide plate that guides light received from a light source and emits the light through a light emission surface, and controls a position for emitting light through the light emission surface, and a liquid crystal display that controls light emission or light transmission depending on a position.

The input device according to the above aspect may further include a sound output device configured to output a sound. The notification controller may change an output from the sound output device to change the method of notification.

The above structure can change the output from the sound output device to allow the user to learn that the input device has received or is about to receive the user operation.

The input device according to the above aspect may further include a tactile stimulator that remotely stimulates a tactile sense of a human body located in a space including the imaging position. The notification controller may change an output from the tactile stimulator to change the method of notification.

The above structure can change the output from the tactile stimulator to allow the user to learn that the input device has received or is about to receive the user operation.

In the input device according to the above aspect, the first light guide plate may include a plurality of partial light guide plates. Each of the plurality of partial light guide plates may include a light-guiding area between an incident surface receiving light from the light source and a light-emitting area on the light emission surface, and at least one of the partial light guide plates may be adjacent to the light emission surface of another partial light guide plate and at least partially overlap in the light-guiding area of the other partial light guide plate.

The above structure can extend the distance from the light source and the imaging position. The longer distance reduces the apparent beam divergence of the light from the light source, which depends on the size (width) of the light source. This enables clearer images to be formed (appear). Additionally, the input device has a longer distance between the light source and the areas for displaying the images. This allows an image to appear in an area having larger light beam divergence (in other words, larger images can appear).

In the input device according to the above aspect, the image may include a plurality of images formed at a plurality of positions, and one or more of the plurality of images may each correspond to a number or a character. The input device may output input character information in accordance with a sensing result from the input sensor.

The above structure is applicable to, for example, a code number input device.

In the input device according to the above aspect, the first light guide plate may include a plurality of optical path changers that redirect light guided within the first light guide plate to be emitted through the light emission surface, and the light redirected by the optical path changers and emitted through the light emission surface may converge at a predetermined position in a space to form an image.

An input device according to another aspect of the present invention includes a first light guide plate that guides light received from a light source and emits the light through a light emission surface to form an image in a screenless space, a sensor that detects an object in a space including an imaging position at which the image is formed, an input sensor that senses a user input in response to detection of the object by the sensor, a light controller that is located adjacent to the light emission surface of the first light guide plate or located opposite to the light emission surface, and changes a light emission state or a light transmission state depending on a position, and a notification controller that controls the light controller in response to a detection result from the sensor.

To notify the user that the input device has received the operation on the input device performed with the object, the structure below may be used. More specifically, two light guide plates, or specifically one for forming (displaying) the image and the other for notifying that an input on the image has been performed, may be used for each area in which the corresponding image is formed. However, this structure may include more light guide plates for more images to complicate the structure of the input device.

The above structure includes the light controller that changes the light emission state or the light transmission state depending on the position and eliminates the need for many light guide plates. This simplifies the structure of the input device.

In the input device according to the above aspect, the light controller may be any one selected from a light emitter that controls light emission of a plurality of light emitters arranged at a plurality of positions, a second light guide plate that guides light received from a light source and emits the light through a light emission surface, and control a position for emitting light through the light emission surface, and a liquid crystal display that controls light emission or light transmission depending on a position.

The input device according to one aspect of the present invention includes a first light guide plate that guides light received from a light source and emits the light through a light emission surface to form an image in a space, a sensor that detects an object in a space including an imaging position at which the image is formed, an input sensor that senses a user input in response to detection of the object by the sensor, and an image formation controller that changes a formation state of the image formed by the first light guide plate when the input sensor detects a user input operation performed by moving the object within an image formation area including the imaging position of the image.

The above structure changes the formation state of the image in accordance with the movement (motion) of the object. More specifically, the input device can receive various input instructions from the user and change the formation state of the image in response to the input instructions.

An input device according to still another aspect of the present invention includes a first light guide plate that guides light received from a light source and emits the light through a light emission surface to form an image in a space, a sensor that detects an object in a space including an imaging position at which the image is formed, an input sensor that senses a user input in response to detection of the object by the sensor, and an imaging plane presenter having a flat surface portion in an imaging plane including an image formation area including the imaging position of the image. The flat surface portion is at a position different from the image formation area.

A known input device may cause the user to have a poorer sense of distance from the position of an image formed in a space. The above structure allows the user to view an image while focusing on the flat surface portion of the imaging plane presenter. The user can readily focus on the image to easily feel a stereoscopic effect of the image.

An input device according to still another aspect of the present invention includes a first light guide plate that guides light received from a light source and emits the light through a light emission surface to form an image in a space, a sensor that detects an object in a space including an imaging position at which the image is formed, an input sensor that senses a user input in response to detection of the object by the sensor, and a light controller that is located adjacent to the light emission surface of the first light guide plate or located opposite to the light emission surface, and changes a light emission state or a light transmission state depending on a position to display a projected image corresponding to a projected shape of the image formed by the first light guide plate.

As described above, a known input device causes the user to have a poorer sense of distance from the position of an image formed in a space. The above structure allows the user to recognize the projected image as the shadow of the image. Thus, the user can easily have a sense of distance between the image and the first light guide plate and can feel a higher stereoscopic effect of the image.

The input device according to one or more aspects of the present invention recognizes that a user places a finger or another object toward an image formed in a space and notifies the user of the recognition.

### BRIEF DESCRIPTION OF THE DRAWINGS

FIG. 1 is a block diagram of an input device according to a first embodiment of the present invention showing its main components.

FIG. 2 is a plan view of the input device.

FIG. 3 is a schematic cross-sectional view of the input device taken in the arrow direction of line A-A in FIG. 2.

FIG. 4 is a perspective view of a stereo image display included in the input device.

FIG. 5A is a diagram showing a user input on the input device with a pointer reaching a predetermined range from the front surface of a stereo image, and FIG. 5B is a diagram showing the user input on the input device with the pointer reaching the front surface of the stereo image.

FIG. 6A is a plan view of an input device according to a modification of the first embodiment, and FIG. 6B is a cross-sectional view taken in the arrow direction of line A-A in FIG. 6A.

FIG. 7A is a diagram describing the formation of a stereo image on a known stereo image display, and FIG. 7B is a diagram describing the formation of a stereo image in the above input device.

FIG. 8 is a perspective view of an input device according to another modification of the first embodiment.

FIG. 9 is a cross-sectional view of a stereo image display included in the input device.

FIG. 10 is a plan view of the stereo image display.

FIG. 11 is a perspective view of an optical path changer included in the stereo image display.

FIG. 12 is a perspective view of optical path changers showing their arrangement.

FIG. 13 is a perspective view of the stereo image display describing the formation of a stereo image.

FIG. 14 is a perspective view of an input device according to still another modification of the first embodiment.

FIG. 15A is a schematic view of a stereo image formed by the input device in the first embodiment, and FIG. 15B is a schematic view of a stereo image formed by an input device in a modification.

FIG. 16 is a block diagram of an input device according to a second embodiment of the present invention showing its main components.

FIG. 17 is a schematic diagram of the input device.

FIG. 18 is a block diagram of an input device according to a third embodiment of the present invention showing its main components.

FIG. 19 is a plan view of the input device.

FIG. 20 is a schematic cross-sectional view of the input device taken in the arrow direction of line A-A in FIG. 19.

FIG. 21 is a perspective view of an optical path changer arranged on a light-emitting surface included in the input device.

FIG. 22 is a diagram showing the input device with a pointer reaching the front surface of a stereo image.

FIG. 23 is a plan view of the input device in the state shown in FIG. 22.

FIG. 24 is a block diagram of an input device according to a fourth embodiment of the present invention showing its main components.

FIG. 25 is a plan view of the input device.

FIG. 26 is a schematic cross-sectional view of the input device taken in the arrow direction of line A-A in FIG. 25.

FIG. 27 is a diagram showing the input device with a pointer reaching the front surface of a stereo image.

FIG. 28 is a plan view of the input device in the state shown in FIG. 27.

FIG. 29 is a block diagram of an input device according to a fifth embodiment of the present invention showing its main components.

FIG. 30 is a plan view of the input device.

FIG. 31 is a schematic cross-sectional view of the input device taken in the arrow direction of line A-A in FIG. 30.

FIG. 32 is a diagram showing the input device with a pointer reaching the front surface of a stereo image.

FIG. 33 is a plan view of the input device in the state shown in FIG. 32.

FIG. 34 is a perspective view of an input device according to a sixth embodiment of the present invention displaying an image.

FIG. 35 is a cross-sectional view of the input device displaying the image.

FIG. 36 is a block diagram of an input device according to a seventh embodiment of the present invention showing its main components.

FIG. 37 is a schematic view of a stereo image display.

FIG. 38 is a cross-sectional view taken in the arrow direction of line A-A in FIG. 37.

FIG. 39A is a diagram describing the operation of the input device before receiving a user input, FIG. 39B is a diagram describing the operation of the input device receiving a user input, and FIG. 39C is a diagram describing the operation of the input device after receiving the user input.

FIG. 40 is a perspective view of an input device according to a modification of the seventh embodiment.

FIG. 41 is a cross-sectional view of a stereo image display included in the input device.

FIGS. 42A to 42H are diagrams describing uses of the input device.

FIGS. 43A to 43C are diagrams describing the input device used in an input section for an elevator.

FIG. 44 is a diagram describing the input device used in an input section for a warm-water washing toilet seat.

### DETAILED DESCRIPTION

### First Embodiment

An input device 1 according to one embodiment of the present invention will now be described in detail with reference to the drawings.

### Structure of Input Device 1

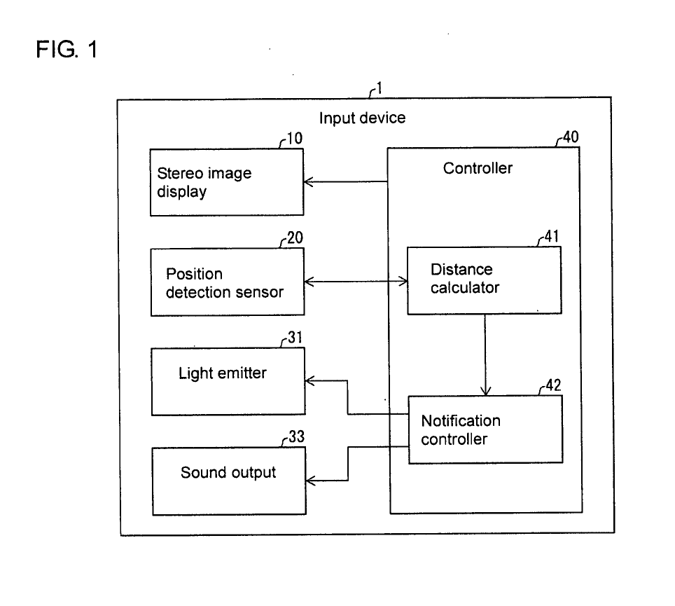

The structure of the input device 1 will now be described with reference to FIGS. 1 to 4.

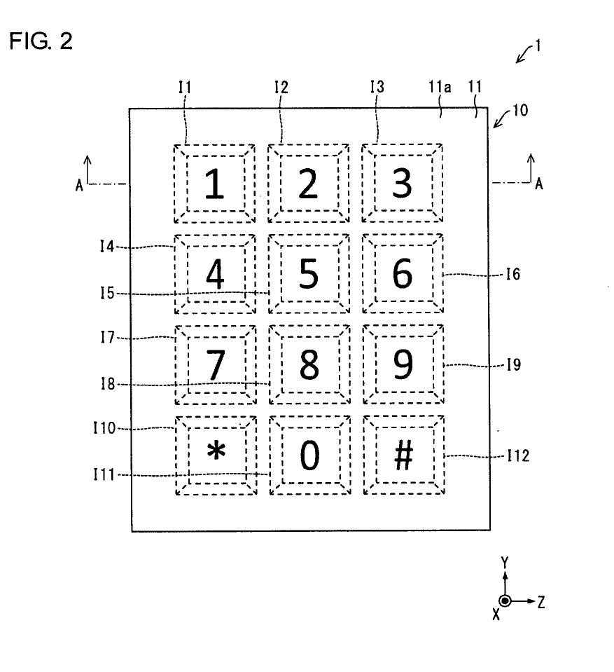

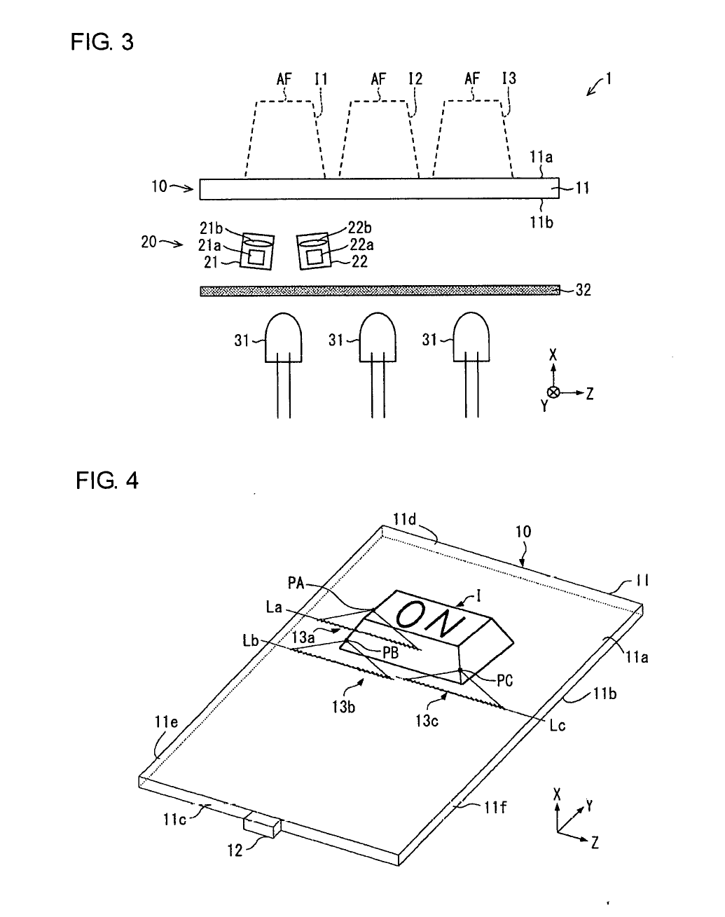

FIG. 1 is a diagram of the input device 1 showing its main components. FIG. 2 is a plan view of the input device 1. FIG. 3 is a schematic cross-sectional view of the input device 1 taken in the arrow direction of line A-A in FIG. 2. For ease of explanation, the positive X-direction in FIG. 2 may be referred to as the forward direction, the negative X-direction as the rearward direction, the positive Y-direction as the upward direction, the negative Y-direction as the downward direction, the positive Z-direction as the rightward direction, and the negative Z-direction as the leftward direction.

As shown in FIGS. 1 to 3, the input device 1 includes a stereo image display 10, a position detection sensor 20 (sensor), a light emitter 31, a diffuser 32, a sound output 33 (sound output device), and a controller 40.

The stereo image display 10 forms stereo images I1 to I12 viewable by a user in a screenless space. The stereo images I1 to I12 may hereafter be referred to as the stereo images I without differentiating the individual images.

FIG. 4 is a perspective view of the stereo image display 10. In FIG. 4, the stereo image display 10 displays a stereo image I, and more specifically, a stereo image I of a button (protruding in the positive X-direction) showing the word ON. As shown in FIG. 4, the stereo image display 10 includes a light guide plate 11 (first light guide plate) and a light source 12.

The light guide plate 11 is rectangular and formed from a transparent resin material with a relatively high refractive index. The material for the light guide plate 11 may be a polycarbonate resin, a polymethyl methacrylate resin, or glass. The light guide plate 11 has an emission surface 11a for emitting light (light emission surface), a back surface 11b opposite to the emission surface 11a, and the four end faces 11c, 11d, 11e, and 11f. The end face 11c is an incident surface that allows light emitted from the light source 12 to enter the light guide plate 11. The end face 11 d is opposite to the end face 11c. The end face 11e is opposite to the end face 11f. The light guide plate 11 guides the light from the light source 12 to diverge within a plane parallel to the emission surface 11a. The light source 12 is, for example, a light-emitting diode (LED).

The light guide plate 11 has multiple optical path changers 13 on the back surface 11b, including an optical path changer 13a, an optical path changer 13b, and an optical path changer 13c. The optical path changers 13 are arranged substantially sequentially and extend in Z-direction. In other words, the multiple optical path changers 13 are arranged along predetermined lines within a plane parallel to the emission surface 11a. Each optical path changer 13 receives, across its length in Z-direction, the light emitted from the light source 12 and guided by the light guide plate 11. The optical path changer 13 substantially converges the light incident at positions across the length of each optical path changer 13 to a fixed point corresponding to the optical path changer 13. FIG. 4 shows the optical path changer 13a, the optical path changer 13b, and the optical path changer 13c selectively from the optical path changers 13, showing the convergence of light reflected by the optical path changer 13a, the optical path changer 13b, and the optical path changer 13c.

More specifically, the optical path changer 13a corresponds to a fixed point PA on the stereo image I. Light from positions across the length of the optical path changer 13a converges at the fixed point PA. Thus, the wave surface of light from the optical path changer 13a appears to be the wave surface of light emitted from the fixed point PA. The optical path changer 13b corresponds to a fixed point PB on the stereo image I. Light from positions across the length of the optical path changer 13b converges at the fixed point PB. In this manner, light from positions across the length of an optical path changer 13 substantially converges at a fixed point corresponding to the optical path changer 13. Any optical path changer 13 thus provides the wave surface of light that appears to be emitted from the corresponding fixed point. Different optical path changers 13 correspond to different fixed points. The set of multiple fixed points corresponding to the optical path changers 13 forms a user-recognizable stereo image I in a space (more specifically, in a space above the emission surface 11a of the light guide plate 11). The surface of a stereo image I showing a number or a character as shown in FIGS. 3 and 4 will be referred to as the front surface AF.

As shown in FIG. 4, the optical path changer 13a, the optical path changer 13b, and the optical path changer 13c are arranged along a line La, a line Lb, and a line Lc. The lines La, Lb, and Lc are substantially parallel to Z-direction. Any optical path changers 13 are arranged substantially sequentially along lines parallel to Z-direction.

The stereo image display 10 hereafter displays stereo images I1 to I12 as shown in FIG. 2. More specifically, the stereo image display 10 described below has multiple optical path changers 13 on the back surface 11b of the light guide plate 11 to display the stereo images I1 to I12. The stereo images I1 to I9 are stereo images of buttons showing numbers 1 to 9. The stereo image I10 is a stereo image of a button showing an asterisk (*). The stereo image I11 is a stereo image of a button showing a number 0. The stereo image I12 is a stereo image of a button showing a sharp sign (#).

The position detection sensor 20 detects the position of a pointer (object) F (a user's finger in the present embodiment) used by a user for input to the input device 1. The position detection sensor 20 is a reflective position detection sensor. The position detection sensor 20 is provided for each of the stereo images I1 to I12 displayed by the stereo image display 10. Each position detection sensor 20 is arranged opposite to the stereo images I1 to I12 across the stereo image display 10 (or in the negative X-direction of the stereo image display 10). For simplicity, FIG. 4 shows only the position detection sensor 20 for the stereo image I1. The position detection sensor 20 includes a phototransmitter 21 and a photoreceiver 22.

The phototransmitter 21 emits light into a space above the emission surface 11a. The phototransmitter 21 includes a light emitter 21a and a light emitter lens 21b. The light emitter 21a emits detection light forward (in the positive X-direction) to detect a pointer F. The light emitter 21a may be a light source that emits invisible light such as infrared light, and for example, an infrared LED. The light emitter 21a emits invisible light as detection light, which prevents the user from recognizing the detection light. The light emitter lens 21b reduces the divergence of light emitted from the light emitter 21a. The detection light emitted from the light emitter 21a passes through the light emitter lens 21b and then the stereo image display 10 (more specifically, the emission surface 11a and the back surface 11b ) and enters the space above the emission surface 11a.

The photoreceiver 22 receives light reflected from the pointer F after emitted from the phototransmitter 21. The photoreceiver 22 includes a photosensor 22a and a light receiver lens 22b. The photosensor 22a receives light. The light receiver lens 22b condenses light for the photosensor 22a.

When the pointer F is located near the stereo image I, the detection light emitted from the phototransmitter 21 for the stereo image I is reflected by the object F. The light reflected from the object F transmits through the light guide plate 11 and travels to the photoreceiver 22 for the stereo image I. The reflected light is condensed toward the photosensor 22a by the light receiver lens 22b in the photoreceiver 22 and received by the photosensor 22a.

The position detection sensor 20 calculates the distance between the position detection sensor 20 and the pointer F in the front-and-rear direction (X-direction) based on the intensity of the light reflected from the pointer F and received by the photoreceiver 22 after emitted from the phototransmitter 21. The position detection sensor 20 outputs the calculated distance in the front-and-rear direction between the position detection sensor 20 and the pointer F to a distance calculator 41 in the controller 40 (described later).

The light emitter 31 is a light source that emits light toward the stereo image I in response to an instruction from a notification controller 42 (described later). The light emitter 31 is provided for each of the stereo images I1 to I12 displayed by the stereo image display 10. Each light emitter 31 is arranged below the position detection sensor (in the negative X-direction). The light emitter 31 is, for example, an LED light source.

The diffuser 32 diffuses and projects the light emitted from the light emitter 31. The diffuser 32 is arranged between the light guide plate 11 and the light emitters 31 (more specifically, between the position detection sensors 20 and the light emitters 31). The diffuser 32, which diffuses the light emitted from the light emitters 31, allows the user to easily view the light emitted from the light emitters 31.

The sound output 33 outputs a sound in response to an instruction from the notification controller 42 (described later). The sound output 33 can change the level of a sound (sound volume). The sound output 33 may be any known sound output device that can output a sound and change the volume of the sound. The sound output 33 may also change the pitch of a sound.

The controller 40 centrally controls the components of the input device 1. The controller 40 includes the distance calculator 41 and the notification controller 42.

The distance calculator 41 calculates the distance between the pointer F and the front surface AF of the stereo image I based on the distance in the front-and-rear direction between the position detection sensor 20 and the pointer F output from the position detection sensor 20 (more specifically, the photoreceiver 22). The distance calculator 41 outputs the calculated distance between the pointer F and the front surface AF of the stereo image I to the notification controller 42.

The notification controller 42 changes the method of notification to the user by the light emitter 31 and the sound output 33 in accordance with the distance between the pointer F and the front surface AF of the stereo image I calculated by the distance calculator 41. The notification controller 42 functions as an input sensor that senses a user input in response to detection of the pointer F by the position detection sensor 20. The notification controller 42 also functions as a light emitter that controls the light emission by the light emitter 31.

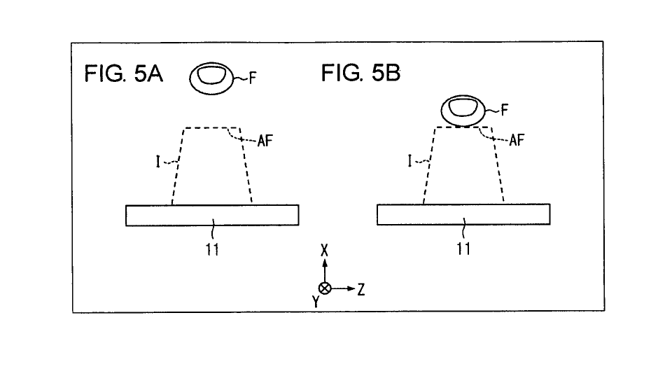

FIG. 5A is a diagram showing a user input on the input device 1 with the pointer F reaching a predetermined range from the front surface AF of the stereo image I. FIG. 5B is a diagram showing the user input on the input device 1 with the pointer F reaching the front surface AF of the stereo image I. For simplicity, FIGS. 5A and 5B show only a single stereo image I.

Control for Pointer F Reaching Predetermined Range from Front Surface AF

Referring now to FIG. 5A, the control performed by the notification controller 42 when the pointer F reaches a predetermined range from the front surface AF will be described. When the notification controller 42 determines that the pointer F has reached a predetermined range from the front surface AF (hereafter referred to as a nearby space) based on the distance between the pointer F and the front surface AF of the stereo image I calculated by the distance calculator 41, the notification controller 42 outputs an instruction to emit light to, selectively from the light emitters 31 for the stereo images I1 to I12, the light emitter 31 for the stereo image I for which the pointer F has reached the nearby space. The notification controller 42 also outputs an instruction to emit no light to each of the other light emitters 31. More specifically, the notification controller 42 outputs an instruction to the light emitter 31 to emit light with a higher luminance at a smaller distance between the pointer F and the front surface AF of the stereo image I. This process allows the stereo image I for which the pointer F has reached the nearby space to be viewed by the user as if the image is shining.

When the notification controller 42 determines that the pointer F has reached the nearby space of one of the stereo images I, the notification controller 42 outputs an instruction to the sound output 33 to output a sound. More specifically, the notification controller 42 outputs an instruction to the sound output 33 to output a sound having a larger volume at a smaller distance between the pointer F and the front surface AF of the stereo image I.

### Control for Pointer F Reaching Front Surface AF

The control described below is performed by the notification controller 42 when the pointer F reaches the front surface AF as shown in FIG. 5B. When the notification controller 42 determines that the pointer F has reached the front surface AF based on the distance between the pointer F and the front surface AF of the stereo image I calculated by the distance calculator 41, the notification controller 42 notifies the user that the input device 1 has received the user input. More specifically, the notification controller 42 outputs an instruction to stop the light projection to the light emitter 31 for the stereo image I, for which the pointer F has reached the front surface AF.

When the notification controller 42 determines that the pointer F has reached the front surface AF of one of the stereo images I, the notification controller 42 outputs an instruction to the sound output 33 to output a different sound (e.g., a sound with a different pitch). The sound is different from the sound output by the sound output 33 when determining that the pointer F has reached the nearby space of any stereo image I.

In this manner, the notification controller 42 in the input device 1 according to the present embodiment changes the method of notification to the user in accordance with the distance detected by the position detection sensor 20 between a stereo image I and the pointer F. More specifically, when the notification controller 42 determines that the pointer F has reached the predetermined range from the front surface AF of the stereo image I, the notification controller 42 outputs (1) an instruction to the light emitter 31 to emit light with a higher luminance at a smaller distance between the pointer F and the front surface AF of the stereo image I (in other words, outputs an instruction to change the display state of the image), and (2) an instruction to the sound output 33 to output a sound having a larger volume at a smaller distance between the pointer F and the front surface AF of the stereo image I.

This structure uses light emitted from the light emitter 31 or a sound output from the sound output 33 to notify the user that the pointer F is reaching the front surface AF (more specifically, the input device 1 is about to receive an input operation performed with the pointer F). The user can thus learn that the input operation with the pointer F is recognized by the input device 1. This eliminates (relieves) the user's worry that the input device 1 may not recognize the operation.

In the input device 1 according to the present embodiment, the notification controller 42 controls the light emitter 31 and the sound output 33 to use a different method of notification to the user for when the pointer F is located in the nearby space and for when the pointer F reaches the front surface AF.

The user can thus confirm that the input device 1 has received the operation performed with the pointer F. This eliminates the user's worry that the input device 1 may not receive the input and provides the user with a sense of operation on the input device 1.

To notify the user that the input device 1 has received the user operation on the input device 1 performed with the pointer F, the structure below may be used. More specifically, two light guide plates, or specifically one for forming (displaying) the stereo image I and the other for notifying that an input on the stereo image I has been performed, may be used for each area in which the corresponding stereo image I is formed. However, this structure may include more light guide plates for more stereo images I (e.g., 12 stereo images I formed in the present embodiment) to complicate the structure of the input device.

In contrast, the input device 1 according to the present embodiment has a simplified structure including the light emitter 31 that notifies the user that the input device 1 has received the user operation on the input device 1 performed with the pointer F.

The input device 1 according to the present embodiment forms the multiple stereo images I for each of which the nearby space is defined. When the pointer F is detected in one of the defined nearby spaces, the notification controller 42 provides a notification identifying the stereo image I at the position included in this nearby space. More specifically, the notification controller 42 causes the light emitter 31 for this stereo image I to emit light.

This structure notifies the user of the stereo image I selectively from the stereo images I1 to I12, for which the user operation is about to be received by the input device 1. The user can thus confirm that the input device 1 is about to receive the input operation on the intended stereo image I. This eliminates the user's worry that the input device 1 may receive an input to an unintended stereo image I.

In the input device according to one embodiment of the present invention, when the pointer F reaches a nearby space, the notification controller 42 may also control the light emitter 31 associated with the nearby space to switch light on and off more quickly at a smaller distance between the pointer F and the front surface AF of the stereo image I. This structure also notifies the user that the pointer F is reaching the front surface AF of the stereo image I.

In the input device according to the present embodiment, when the pointer F reaches a nearby space, the notification controller 42 outputs an instruction to the sound output 33 to output a sound. However, the input device according to one embodiment of the present invention is not limited to this structure. The light emitter 31 may emit light to notify the user that the input device 1 is about to receive a user input operation performed with the pointer F when the pointer F reaches a nearby space. In the input device according to one embodiment of the present invention, the notification controller 42 may cause the sound output unit 33 to stop sound output when the pointer F reaches a nearby space.

In the input device according to one embodiment of the present invention, when the pointer F reaches the front surface AF of a stereo image I, the notification controller 42 may output an instruction to the light emitter 31 to emit light with a color different from the color of the light emitted from the light emitter 31 when the pointer F reaches the nearby space. This structure also notifies the user that the input device 1 has received the operation on the input device 1 performed with the pointer F.

The input device may have no power supply depending on the installation location or the use of the input device 1. In this case, the input device 1 may be powered on its on-board battery (internal battery). However, the battery capacity is limited. Thus, the stereo images I are to appear for the shortest time to minimize power consumption. In response to this, the input device according to one embodiment of the present invention may include a sensor for sensing that the user is about to perform an input operation on the input device 1. The sensor may be a button for receiving a user physical operation on the input device 1, or a sensor for sensing that the user has approached the input device 1. Only when the sensor detects the user who is about to perform an input operation on the input device 1, the notification controller 42 activates the stereo image display 10. The stereo image display 10 is activated only when the user performs an input to the input device 1. This structure reduces battery consumption.

The input device 1 according to the present embodiment includes the position detection sensor 20 that is a reflective position detection sensor. However, the input device according to another embodiment of the present invention may include another position detection sensor, which may be a time-of-flight (TOF) sensor. The TOF sensor may calculate the distance between the position detection sensor 20 and the pointer F in the front-and-rear direction (X-direction) based on the time taken from when the light is emitted from the phototransmitter 21 to when this light is reflected by the pointer F and received by the photoreceiver 22.

In the input device 1 according to the present embodiment, when the notification controller 42 determines that the pointer F has reached the nearby space of one of the stereo images I, the notification controller 42 outputs an instruction to the sound output 33 to output a sound having a larger volume at a smaller distance between the pointer F and the front surface AF of the stereo image I. However, the input device according to one embodiment of the present invention is not limited to this structure. The notification controller 42 may output an instruction to the sound output 33 to switch its sound output on and off more quickly at a smaller distance between the pointer F and the front surface AF of the stereo image I when the notification controller 42 determines that the pointer F has reached the nearby space of one of the stereo images I. The notification controller 42 may further output an instruction to the sound output 33 to output a sound with a pitch higher (or lower) at a smaller distance between the pointer F and the front surface AF of the stereo image I when the notification controller 42 determines that the pointer F has reached the nearby space of one of the stereo images I.

As described above, the input device 1 forms the stereo images I at different positions with each stereo image I corresponding to a number or a character. The input device 1 may thus be used as a code number input device that outputs input character information in accordance with sensing results from the position detection sensor 20. The input device 1 may also be used as, for example, an input section for an automated teller machine (ATM), an input section for a credit card reader, an input section for unlocking a cashbox, and an input section for unlocking a door by entering a code number. A known code number input device receives an input operation performed by placing a finger into physical contact with the input section. In this case, the fingerprint and the temperature history remain on the input section, possibly revealing a code number to a third party. In contrast, the input device 1 used as an input section leaves no fingerprint or temperature history and prevents a code number from being revealed to a third party. In another example, the input device 1 may also be used as a ticket machine installed in a station or other facilities.

### First Modification

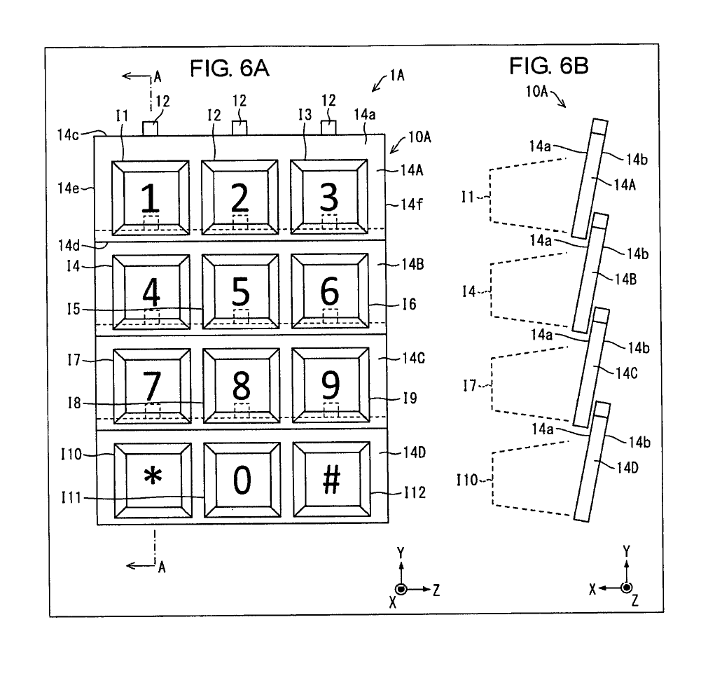

An input device 1A according to a modification of the input device 1 according to the first embodiment will now be described with reference to FIGS. 6A and 6B. For convenience of explanation, the components having the same functions as the components described in the above embodiment are given the same reference numerals as those components and will not be described.

FIG. 6A is a plan view of the input device 1A. FIG. 6B is a cross-sectional view taken in the arrow direction of line A-A in FIG. 6A.

As shown in FIGS. 6A and 6B, the input device 1A includes a stereo image display 10A in place of the stereo image display 10 in the first embodiment.

The stereo image display 10A includes four light guide plates 14A to 14D (partial light guide plates). The light guide plates 14A to 14D have substantially the same structure as the light guide plate 11 according to the first embodiment. The light guide plate 14A will be described focusing on its differences from the light guide plate 11.

The light guide plate 14A has an emission surface 14a (light emission surface) for emitting light, a back surface 14b opposite to the emission surface 14a, and the four end faces 14c, 14d, 14e, and 14f. Each of the four light guide plates 14A to 14D has optical path changers 13 on the back surface 14b for forming three stereo images I. To form the three stereo images I, the light guide plate 14A has light sources 12 on the end face 14c corresponding to the stereo Images I. The light guide plate 14A forms the stereo images I1 to 13, the light guide plate 14B forms the stereo images I4 to I6, the light guide plate 14C forms the stereo images 17 to 19, and the light guide plate 14D forms the stereo images I10 to I12.

As shown in FIG. 6B, the light guide plates 14A to 14D are inclined with respect to the vertical direction (Y-direction) in a cross section parallel to the XY plane. As viewed from the front, the light guide plate 14A overlaps the emission surface 14a of the light guide plate 14B. Similarly, the light guide plate 14B overlaps the emission surface 14a of the light guide plate 14C, and the light guide plate 14C overlaps the emission surface 14a of the light guide plate 14D. In other words, the four light guide plates 14A to 14D in the input device 1A substantially serve as a single light guide plate.

In this manner, the input device 1A has light-guiding areas between the end faces 14c that receive light from the light sources 12 and the light-emitting areas on the emission surfaces 14a. The light guide plates 14A to 14C are adjacent to the emission surfaces 14a of the corresponding light guide plates 14B to 14D and at least partially overlap the light-guiding areas (or the light guide plates 14B to 14D).

This structure can extend the distance traveled by light from the light sources 12 to form the stereo images I via the optical path changers 13. This longer distance reduces the apparent beam divergence of the light from the light sources 12, which depends on the size (width) of the light sources 12 (in other words, the light sources 12 function as point sources). As a result, clearer stereo images I are formed (appear).

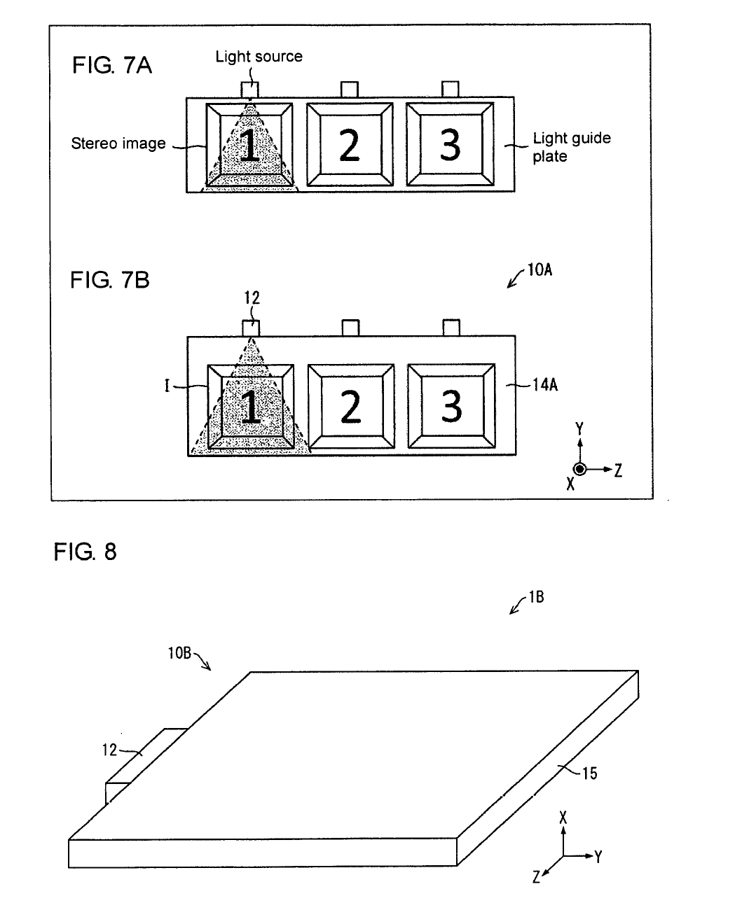

FIG. 7A is a diagram describing the formation of a stereo image on a known stereo image display. FIG. 7B is a diagram describing the formation of a stereo image by the stereo image display 10A. As shown in FIG. 7A, the known arrangement of multiple light guide plates without overlaps (in the same plane) has a shorter distance between the light sources and the stereo image display areas. Thus, areas having smaller light beam divergence are used to form clear stereo images. In contrast, the stereo image display 10A with the structure described above has a longer distance between the light sources 12 and the areas for displaying the stereo images I in the light guide plate 14A, for example, as shown in FIG. 7B. This longer distance allows a stereo image I to appear in an area having larger light beam divergence (in other words, large stereo images I can appear).

### Second Modification

An input device 1B as another modification of the input device 1 according to the first embodiment will now be described with reference to FIGS. 8 to 13. For convenience of explanation, the components having the same functions as the components described in the embodiment are given the same reference numerals as those components and will not be described.

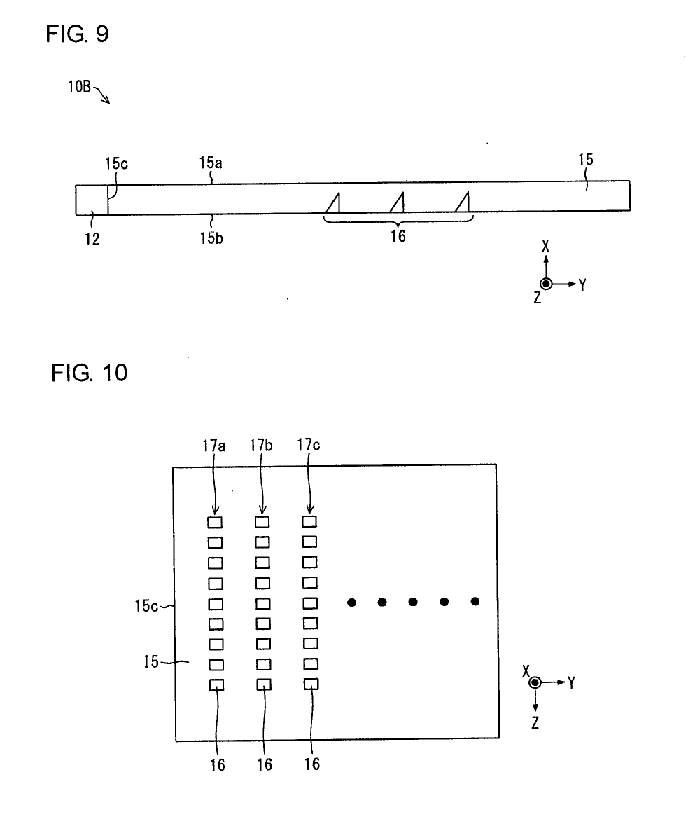

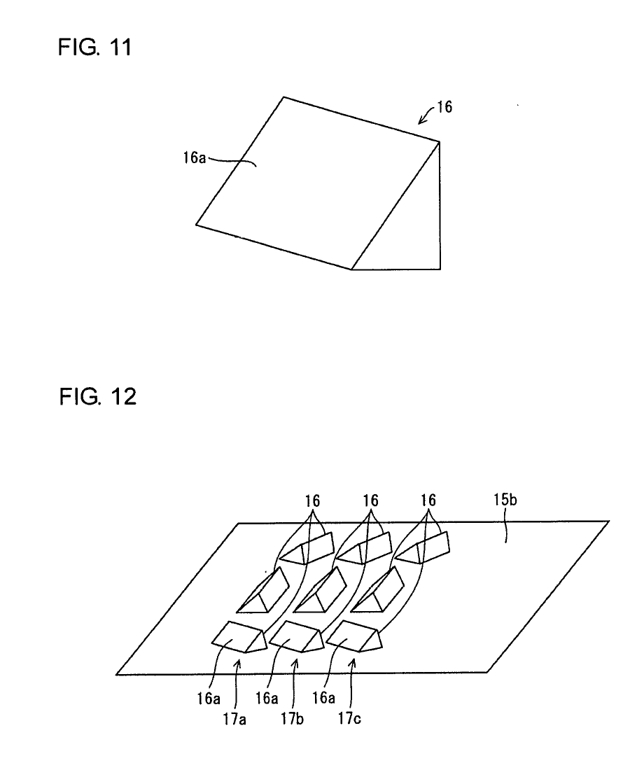

FIG. 8 is a perspective view of the input device 1B. FIG. 9 is a cross-sectional view of a stereo image display 10B included in the input device 1B. FIG. 10 is a plan view of the stereo image display 10B. FIG. 11 is a perspective view of an optical path changer 16 included in the stereo image display 10B.

As shown in FIG. 8, the input device 1B includes the stereo image display 10B in place of the stereo image display 10 in the first embodiment. The input device 1 according to the first embodiment and the input device 1B in this modification are the same except that the stereo image display 10B forms a stereo image I. The formation of a stereo image I by the stereo image display 10B will now be described. FIGS. 8 to 13 do not show components other than the stereo image display 10B.

As shown in FIGS. 8 and 9, the stereo image display 10B includes a light source 12 and a light guide plate 15 (first light guide plate).

The light guide plate 15 guides light (incident light) received from the light source 12. The light guide plate 15 is formed from a transparent resin material with a relatively high refractive index. The material for the light guide plate 15 may be a polycarbonate resin or a polymethyl methacrylate resin. In this modification, the light guide plate 15 is formed from a polymethyl methacrylate resin. As shown in FIG. 9, the light guide plate 15 has an emission surface 15a (light emission surface), a back surface 15b, and an incident surface 15c.

The emission surface 15a emits light guided within the light guide plate 15 and redirected by optical path changers 16 (described later). The emission surface 15a is a front surface of the light guide plate 15. The back surface 15b is parallel to the emission surface 15a and has the optical path changers 16 (described later) arranged on it. The incident surface 15c receives light emitted from the light source 12, which then enters the light guide plate 15.

The light emitted from the light source 12 enters the light guide plate 15 through the incident surface 15c. The light is then totally reflected by the emission surface 15a or the back surface 15b and is guided within the light guide plate 15.

As shown in FIG. 9, the optical path changers 16 are arranged on the back surface 15b and inside the light guide plate 15. The optical path changers 16 redirect the light guided within the light guide plate 15 to be emitted through the emission surface 15a. The multiple optical path changers 16 are arranged on the back surface 15b of the light guide plate 15.

As shown in FIG. 10, the optical path changers 16 are arranged parallel to the incident surface 15c. As shown in FIG. 11, each optical path changer 16 is a triangular pyramid and has a reflective surface 16a that reflects (totally reflects) incident light. The optical path changer 16 may be, for example, a recess on the back surface 15b of the light guide plate 15. The optical path changer 16 may not be a triangular pyramid. As shown in FIG. 10, the light guide plate 15 includes multiple sets of optical path changers 17a, 17b, 17c, and other sets on its back surface 15b. Each set includes multiple optical path changers 16.

FIG. 12 is a perspective view of the optical path changers 16 showing their arrangement. As shown in FIG. 12, the optical path changer sets 17a, 17b, 17c, and other sets each include multiple optical path changers 16 arranged on the back surface 15b of the light guide plate 15 with different reflective surfaces 16a forming different angles with the direction of incident light. This arrangement enables the optical path changer sets 17a, 17b, 17c, and other sets to redirect incident light to be emitted in various directions through the emission surface 15a.

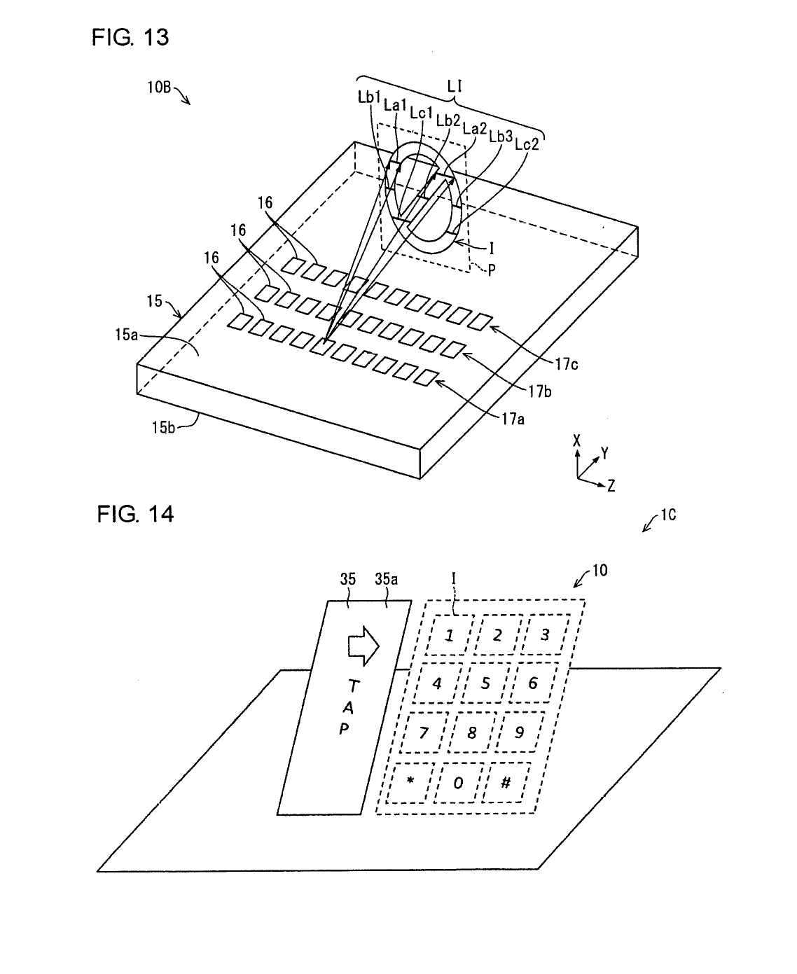

The formation of a stereo image I by the stereo image display 10B will now be described with reference to FIG. 13. In this embodiment, light redirected by optical path changers 16 is used to form a stereo image I that is a plane image on a stereo imaging plane P perpendicular to the emission surface 15a of the light guide plate 15.

FIG. 13 is a perspective view of the stereo image display 10B describing the formation of a stereo image I. In this embodiment, the stereo image I formed on the stereo imaging plane P is a sign of a ring with a diagonal line inside.

In the stereo image display 10B, for example, light redirected by each optical path changer 16 in the optical path changer set 17a intersects with the stereo imaging plane P at a line La1 and a line La2 as shown in FIG. 13. The intersections with the stereo imaging plane P form line images LI as part of the stereo image I. The line images LI are parallel to the YZ plane. In this manner, light from the multiple optical path changers 16 included in the optical path changer set 17a forms the line images LI of the line La1 and the line La2. The light forming the images of the line La1 and the line La2 may be provided by at least two of the optical path changers 16 in the optical path changer set 17a.

Similarly, light redirected by each optical path changer 16 in the optical path changer set 17b intersects with the stereo imaging plane P at a line Lb1, a line Lb2, and a line Lb3. The intersections with the stereo imaging plane P form line images LI as part of the stereo image I.

Light redirected by each optical path changer 16 in the optical path changer set 17c intersects with the stereo imaging plane P at a line Lc1 and a line Lc2. The intersections with the stereo imaging plane P form line images LI as part of the stereo image I.

The optical path changer sets 17a, 17b, 17c, and other sets form line images LI at different positions in X-direction. The optical path changer sets 17a, 17b, 17c, and other sets in the stereo image display 10B may be arranged at smaller intervals to form the line images LI at smaller intervals in X-direction. Thus, the stereo image display 10B combines the multiple line images LI formed by the light redirected by the optical path changers 16 in the optical path changer sets 17a, 17b, 17c, and other sets to form the stereo image I that is a substantially plane image on the stereo imaging plane P.

The stereo imaging plane P may be perpendicular to the X-, Y-, or Z-axis. The stereo imaging plane P may not be perpendicular to the X-, Y-, or Z-axis. The stereo imaging plane P may not be flat and may be curved. Thus, the stereo image display 10B may form a stereo image I on any (flat or curved) plane in a space using the optical path changers 16. Multiple plane images may be combined to form a three-dimensional image.

### Third Modification

An input device 1C as still another modification of the input device 1 according to the first embodiment will now be described with reference to FIG. 14. For convenience of explanation, the components having the same functions as the components described in the above embodiment are given the same reference numerals as those components and will not be described.

FIG. 14 is a perspective view of the input device 1C in this modification. As shown in FIG. 14, the input device 1C includes a reference 35 (imaging plane presenter) in addition to the components of the input device 1 according to the first embodiment.

The reference 35 is a plate member. The reference 35 has a flat front surface 35a (flat surface portion). As shown in FIG. 14, the reference 35 is placed with the front surface 35a in the same plane as the plane P on which the front surface AF of a stereo image I is formed. In other words, the front surface 35a is arranged on a plane (image formation plane) including the front surface AF of the stereo image I (image formation area) and at a position different from the position of the front surface AF.

When the user views the stereo image I (more specifically, the front surface AF), this structure allows the user to view the stereo image I while focusing on the front surface 35a of the reference 35. The user can readily focus on the stereo image I, and thus can easily feel a stereoscopic effect of the stereo image I.

In this modification, the reference 35 is a plate member. However, the input device according to one embodiment of the present invention is not limited to this modification. More specifically, the reference may be any member located in the plane including the front surface AF of the stereo image I and having a flat surface at a position different from the position of the front surface AF and may have any shape such as a triangular prism, a trapezoidal prism, or a rectangular prism.

### Fourth Modification

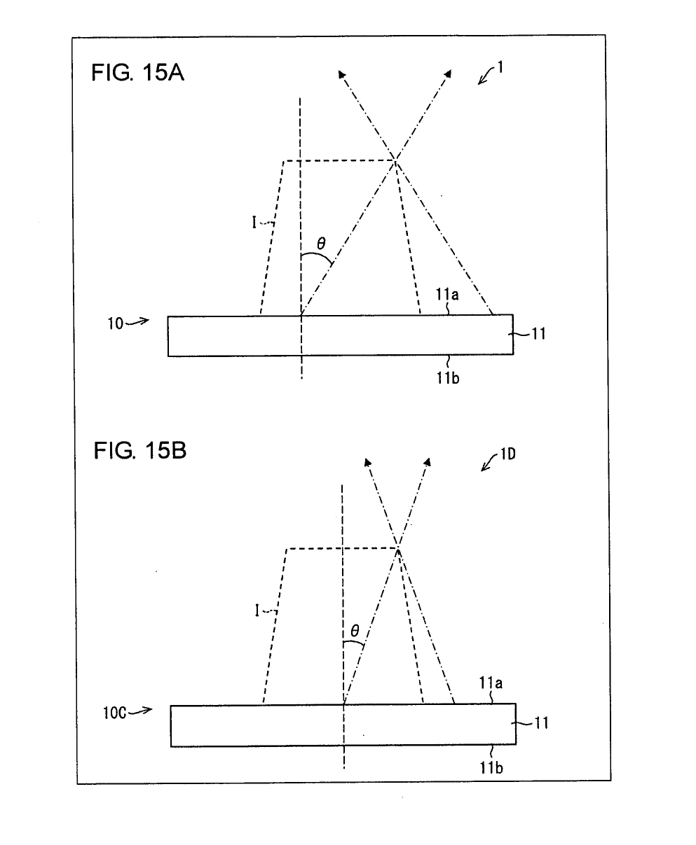

An input device 1D as still another modification of the input device 1 according to the first embodiment will now be described with reference to FIGS. 15A and 15B. For convenience of explanation, the components having the same functions as the components described in the embodiment are given the same reference numerals as those components and will not be described.

FIG. 15A is a schematic view of a stereo image I formed by the input device in the first embodiment. FIG. 15B is a schematic view of a stereo image I formed by the input device 1D in the present modification.

As shown in FIG. 15B, the input device 1D in the present modification includes a stereo image display 10C in place of the stereo image display 10 in the first embodiment.

As shown in FIG. 15A, the stereo image display 10 in the first embodiment has a large angle between the direction of light redirected by both ends of the optical path changers 13 and emitted through the light guide plate 11, and the direction perpendicular to the emission surface 11a of the light guide plate 11 (angle 8 shown in FIG. 15A). The large angle allows a person other than the user performing an input operation on the input device 1 to view the stereo image I. Thus, the input device 1 used as, for example, a code number input device may reveal the user code number to a third party.

In contrast, the input device 1D in the present modification has a smaller angle θ reduced by shortening the lengths in Z-direction of the optical path changers 13 shown in FIG. 4 (e.g., the optical path changer 13a, the optical path changer 13b, and the optical path changer 13c ). The reduced angle prevents a person other than the user performing an input operation on the input device 1D from viewing the stereo image I. More specifically, for example, when the user operates the input device 1D with the eyes at a distance of 300 mm from the light guide plate 11, the lengths in Z-direction of the optical path changers 13 may be adjusted to achieve an angle 8 of 15° or less. With an ordinary person having about 70 mm between the left and right eyes, only the user can view the stereo image I.

### Second Embodiment

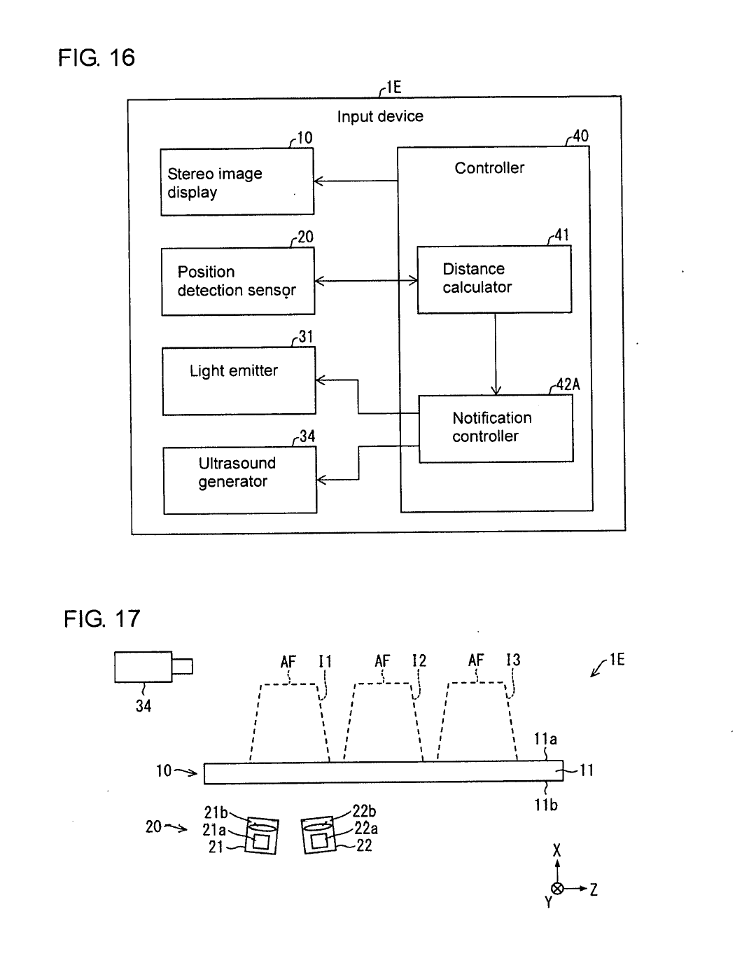

Another embodiment of the present invention will be described below with reference to FIGS. 16 and 17. For convenience of explanation, the components having the same functions as the components described in the above embodiment are given the same reference numerals as those components and will not be described.

FIG. 16 is a block diagram of an input device 1E according to the present embodiment showing its main components. FIG. 17 is a schematic diagram of the input device 1E.

As shown in FIGS. 16 and 17, the input device 1E in the present embodiment includes an ultrasound generator 34 (tactile stimulator) and a notification controller 42A in place of the sound output 33 and the notification controller 42 in the first embodiment.

The ultrasound generator 34 generates an ultrasound in response to an Instruction from the notification controller 42A. The ultrasound generator 34 includes an ultrasound transducer array (not shown) with multiple ultrasound transducers arranged in a grid. The ultrasound generator 34 generates an ultrasound from the ultrasound transducer array and focuses the ultrasound at a predetermined position in the air. The focus of the ultrasound generates static pressure (hereafter referred to as acoustic radiation pressure). With the pointer F on the focal position of the ultrasound, the static pressure applies a pressing force to the pointer F. In this manner, the ultrasound generator 34 can remotely stimulate the tactile sense of a user's finger that is the pointer F. With the pointer F that is a pen for example, the ultrasound generator 34 can stimulate the tactile sense of a user's finger (or hand) through the pen. The level of the pressing force used for the pointer F (user's finger) may be controlled by changing the output generated by the ultrasound transducer array.

When the notification controller 42A in the present embodiment, determines that the pointer F has reached the nearby space of one of the stereo images I, the notification controller 42A controls the ultrasound generator 34 instead of controlling the sound output 33 in the first embodiment. More specifically, when the notification controller 42A determines that the pointer F has reached the nearby space of one of the stereo images I, the notification controller 42A outputs an instruction to the ultrasound generator 34 to alternately generate and stop an ultrasound focused at the position of the pointer F at predetermined intervals. This structure notifies the user that the input device 1E is recognizing the input operation performed with the pointer F. The user can thus learn that the input device 1E is recognizing the user input operation performed with the pointer F.

The notification controller 42A may also output an instruction to the ultrasound generator 34 to shorten the predetermined intervals at a smaller distance between the pointer F and the front surface AF of the stereo image I. This structure also notifies the user that the pointer F is approaching a reception space RD (more specifically, the input device 1 is about to receive the input operation performed with the pointer F).

When the notification controller 42A determines that the pointer F has reached the front surface AF of one of the stereo images I, the notification controller 42A outputs an instruction to the ultrasound generator 34 to stop generating the ultrasound. The user can thus confirm that the input device 1E has received the operation on the input device 1E performed with the pointer F. This eliminates the user's worry that the input device 1E may not receive the operation.

### Third Embodiment

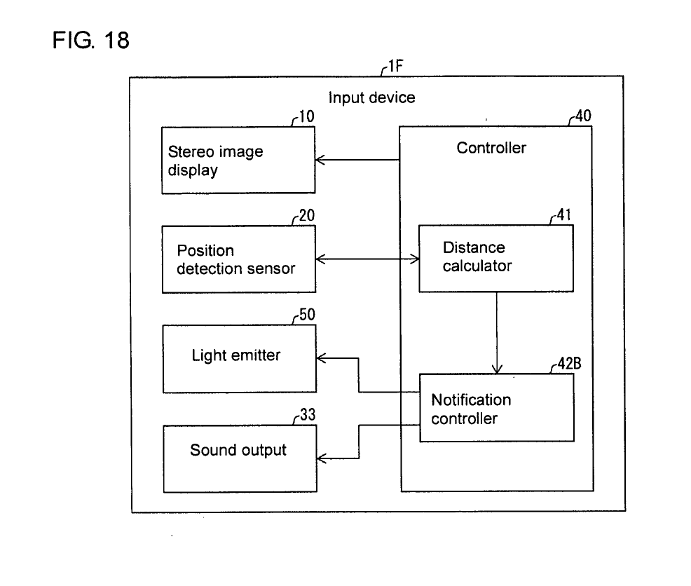

Another embodiment of the present invention will be described below with reference to FIGS. 18 to 23. For convenience of explanation, the components having the same functions as the components described in the above embodiments are given the same reference numerals as those components and will not be described.

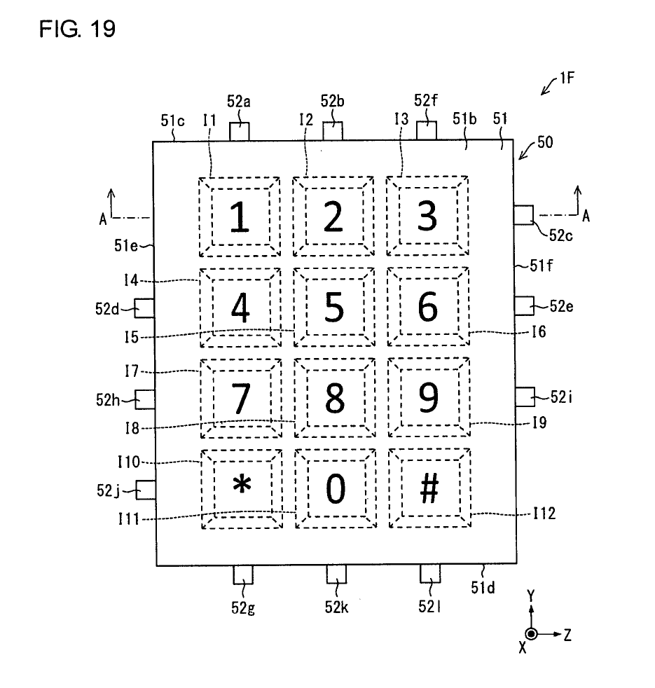

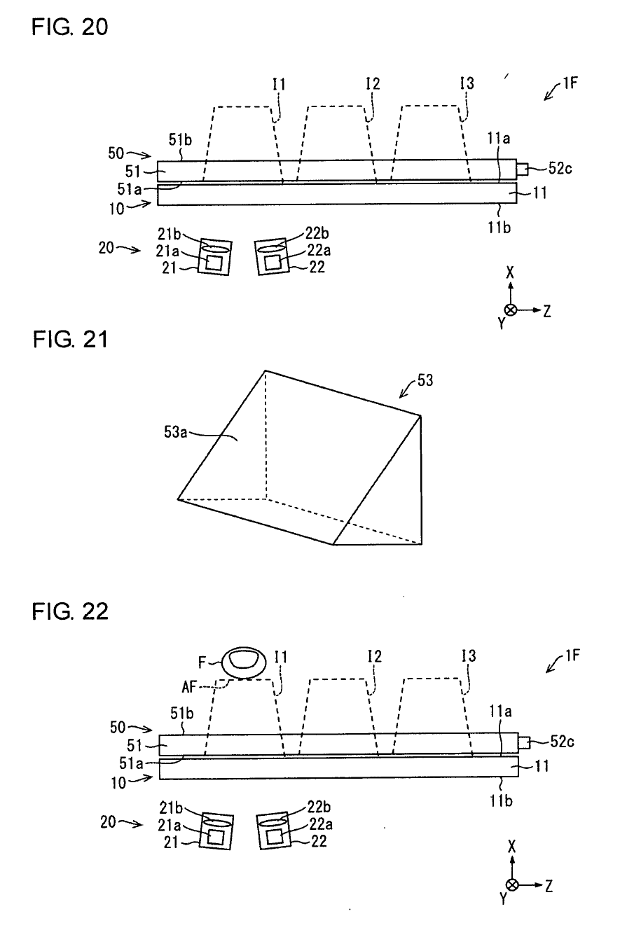

FIG. 18 is a block diagram of an input device 1F according to the present embodiment showing its main components. FIG. 19 is a plan view of the input device 1F. FIG. 20 is a schematic cross-sectional view of the input device 1F taken in the arrow direction of line A-A in FIG. 19.

As shown in FIGS. 18 to 20, the input device 1F in the present embodiment includes a light emitter 50 (a light controller or a second light guide plate) in place of the light emitter 31 and the diffuser 32 in the first embodiment. The input device 1F also includes a notification controller 42B in place of the notification controller 42 in the first embodiment.

As shown in FIGS. 19 and 20, the light emitter 50 includes a light guide plate 51 and twelve light sources 52a to 521. The light sources 52a to 521 may hereafter be referred to as the light sources 52 without differentiating the individual light sources.

The light guide plate 51 is rectangular and formed from a transparent resin material with a relatively high refractive index. The material for the light guide plate 51 may be a polycarbonate resin, a polymethyl methacrylate resin, or glass. The light guide plate 51 has a light-emitting surface 51a for emitting light in predetermined areas, a front surface 51b (light emission surface) opposite to the light-emitting surface 51a, and the four end faces 51c, 51d, 51e, and 51f. The end face 11d is opposite to the end face 11c. The end face 11e is opposite to the end face 11f. The light guide plate 51 is arranged with the light-emitting surface 51a facing the emission surface 11a of the light guide plate 11.

FIG. 21 is a perspective view of an optical path changer 53 arranged on the light-emitting surface 51a. The light-emitting surface 51a has multiple optical path changers 53 arranged on it, each of which is the optical path changer shown in FIG. 21. Each optical path changer 53 has a reflective surface 53a that reflects light.

The light sources 52 emit light to the light guide plate 51. The light emitted from the light sources 52 enters the light guide plate 51. The light is then reflected by the reflective surfaces 53a of the optical path changers 53 and emitted through the front surface 51b.

The light-emitting surface 51a has multiple optical path changers 53 for light emission in each of the areas superposed on the stereo images I1 to I12 as viewed from the front. The light sources 52a to 52I are associated with the multiple optical path changers 53 for light emission in the areas superposed on the stereo images I1 to I12. For example, the light source 52a emits light to the multiple optical path changers 53 for allowing the light emission of the area superposed on the stereo image I1 as viewed from the front. The light sources 52a to 52I emit light to the optical path changers 53 for allowing the light emission of the areas superposed on the stereo images I1 to I12. As shown in FIG. 19, the light source 52a, the light source 52b, and the light source 52f are arranged on the end face 51c. The light source 52g, the light source 52k, and the light source 52I are arranged on the end face 51d. The light source 52d, the light source 52h, and the light source 52j are arranged on the end face 51e. The light source 52c, the light source 52e, and the light source 52i are arranged on the end face 51f. Each light source 52 may include a collimator lens to prevent the light emitted from the light source 52 from being incident on an unassociated optical path changer 53.

The control performed by the notification controller 42B in the present embodiment will be described. In the example described below, the pointer F has reached the front surface AF of the stereo image I1.

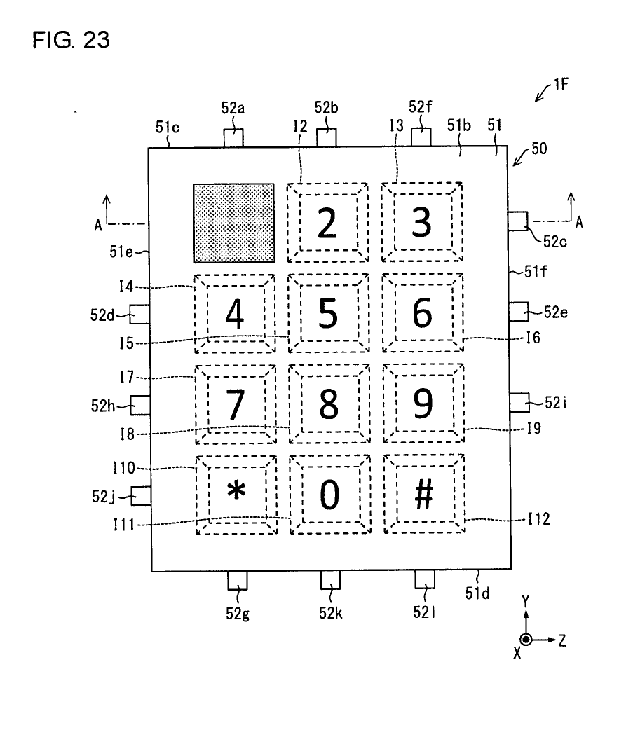

FIG. 22 shows the input device with the pointer F reaching the front surface AF of the stereo image I1. FIG. 23 is a plan view of the input device 1F in the state shown in FIG. 22.

In the present embodiment, as shown in FIG. 22, when the pointer F reaches the front surface AF of the stereo image I1, the notification controller 42B outputs an instruction to the light source 52a associated with the stereo image I to emit light. The light emitted from the light source 52a is reflected by the optical path changers 53 and emitted from the area superposed on the stereo image I1 in the light-emitting surface 51a, as shown in FIGS. 22 and 23. Thus, the user views the light emitted from the stereo image display 10 and the light emitted from the light emitter 50 in the area superposed on the stereo image I1 in the light-emitting surface 51a. As a result, the user cannot view the stereo image I1. The user can thus confirm that the input device 1F has received the operation on the input device 1F performed with the pointer F. This eliminates the user's worry that the input device 1F may not receive the input and provides the user with a sense of operation on the input device 1F.

The light emitted from the light source 12 in the stereo image display 10 and the light emitted from the light sources 52 in the light emitter 50 may have the same color. With the same color, the user cannot easily view the stereo image I when the pointer F reaches its front surface AF. In some embodiments, the light emitted from the light source 12 on the stereo image display 10 and the light emitted from the light sources 52 in the light emitter 50 may have different colors. In this embodiment, the user can view both the stereo image I and the light emission from the light emitter 50, and can confirm that the input device 1F has received the operation on the input device 1F performed with the pointer F.

To reduce the visibility of a stereo image I to the user when the pointer F reaches its front surface AF, the light sources 52 in the light emitter 50 may emit light with high luminance. However, low-luminance light emitted from the light sources 52 in the light emitter 50 may also reduce the visibility of the stereo image I to the user when the pointer F reaches its front surface AF.

The light emitter 50 in the input device 1F according to the present embodiment uses the single light guide plate 51 to emit light in the twelve areas corresponding to the stereo images I1 to I12. However, the input device according to one embodiment of the present invention is not limited to this structure. For example, the input device according to another embodiment of the present invention may include a light emitter having four light guide plates each including three light sources 52, and each light guide plate may emit light in the three areas. This structure prevents light emitted from each light source 52 from being incident on an unintended optical path changer 53. This prevents the stereo images I other than the stereo image I for which the pointer F has reached the nearby space from appearing as unclear images.

The input device 1F in the present embodiment includes the light emitter 50 located adjacent to the emission surface 11a (the front side, which is in the positive X-direction) of the stereo image display 10. However, the input device according to another embodiment of the present invention is not limited to this structure. The input device according to one embodiment of the present invention may include a light emitter 50 located adjacent to the back surface 11b (the rear side, which is in the negative X-direction) of the stereo image display 10. In this structure, the user similarly views the light emitted from the stereo image display 10 and the light emitted from the light emitter 50. As a result, the user cannot recognize the stereo image I.

### Fourth Embodiment

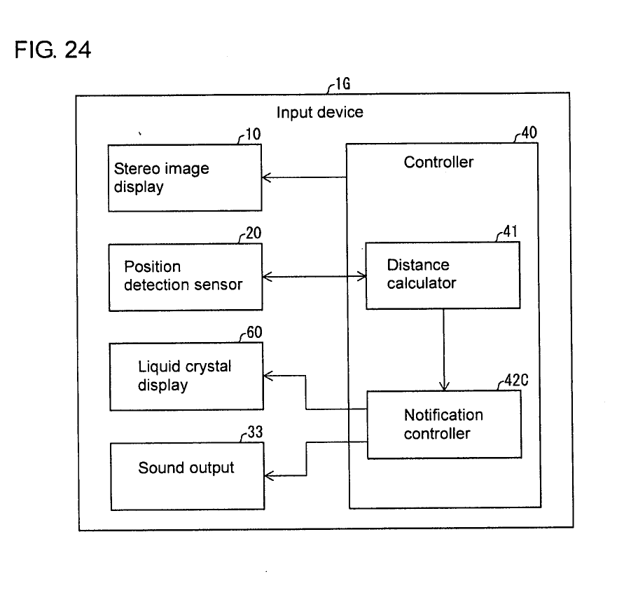

Another embodiment of the present invention will be described with reference to FIGS. 24 to 28. For convenience of explanation, the components having the same functions as the components described in the above embodiments are given the same reference numerals as those components and will not be described.

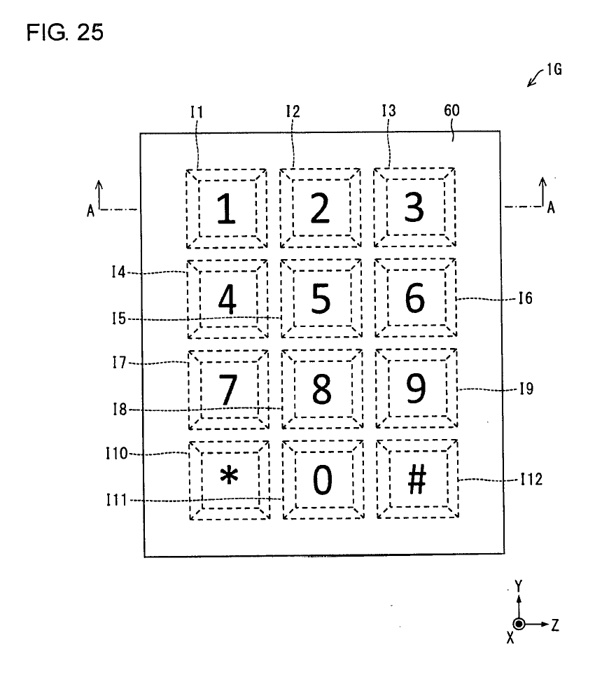

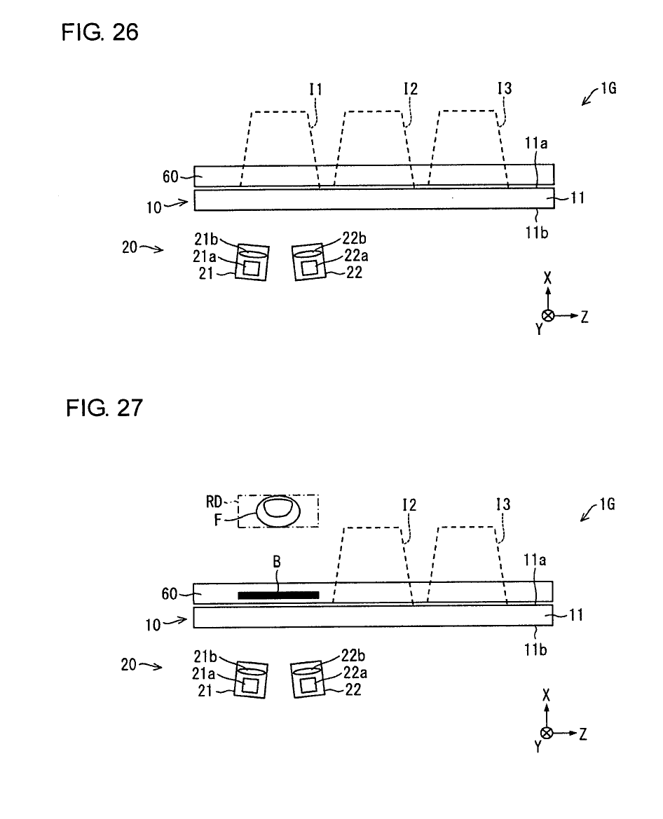

FIG. 24 is a block diagram of an input device 1G according to the present embodiment showing its main components. FIG. 25 is a plan view of the input device 1G. FIG. 26 is a schematic cross-sectional view of the input device 1G taken in the arrow direction of line A-A in FIG. 25.

As shown in FIGS. 24 to 26, the input device 1G in the present embodiment includes a liquid crystal display 60 (a light controller or a liquid crystal display) in place of the light emitter 31 and the diffuser 32 in the first embodiment. The input device 1G also includes a notification controller 42C in place of the notification controller 42 in the first embodiment.

The liquid crystal display 60 is located adjacent to the emission surface 11a of the stereo image display 10 and controls the emission or the transmission of light emitted from the stereo image display 10. The liquid crystal display 60 is a liquid crystal shutter. The liquid crystal display 60 has substantially the same structure as a known liquid crystal shutter, and its differences from a known liquid crystal shutter will be described. The liquid crystal display 60 functions as a light controller that changes the emission state or the transmission state of light emitted from the stereo image display 10.

The liquid crystal display 60 can control the light transmittance of the areas superposed on the stereo images I1 to I12 as viewed from the front by controlling the molecular arrangement and orientation of the liquid crystal using voltage applied externally.

The control performed by the notification controller 42C in the present embodiment will now be described. In the example described below, the pointer F has reached the front surface AF of the stereo image I1.

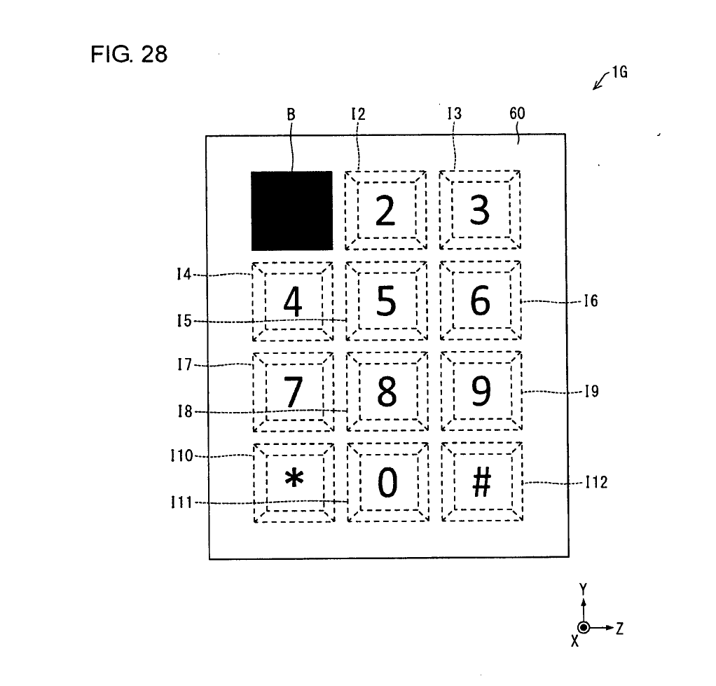

FIG. 27 shows the input device with the pointer F reaching the front surface AF of the stereo image I1. FIG. 28 is a plan view of the input device 1G in the state shown in FIG. 27.

In the present embodiment, as shown in FIG. 27, when the pointer F reaches the front surface AF of the stereo image I1, the notification controller 42C outputs an instruction to the liquid crystal display 60 to shield the light in the area superposed on the stereo image I1 as viewed from the front (area B in FIG. 28) (in other words, to achieve a transmittance of 0%). As a result, the light emitted from the stereo image display 10 to form the stereo image I1 cannot transmit through the area B. The stereo image I1 is not formed as shown in FIG. 27, and the area B turns black. The user can thus confirm that the input device 1G has received the operation on the input device 1G performed with the pointer F. This eliminates the user's worry that the input device 1G may not receive the input and provides the user with a sense of operation on the input device 1G.

When the area B shields light, the notification controller 42C outputs an instruction to the liquid crystal display 60 to transmit the light with, for example, a duty ratio of 1/10 (e.g., to alternately shield light for 0.9 seconds and transmit light for 0.1 seconds). The position detection sensor 20 thus maintains the position detection of the pointer F.

### Fifth Embodiment

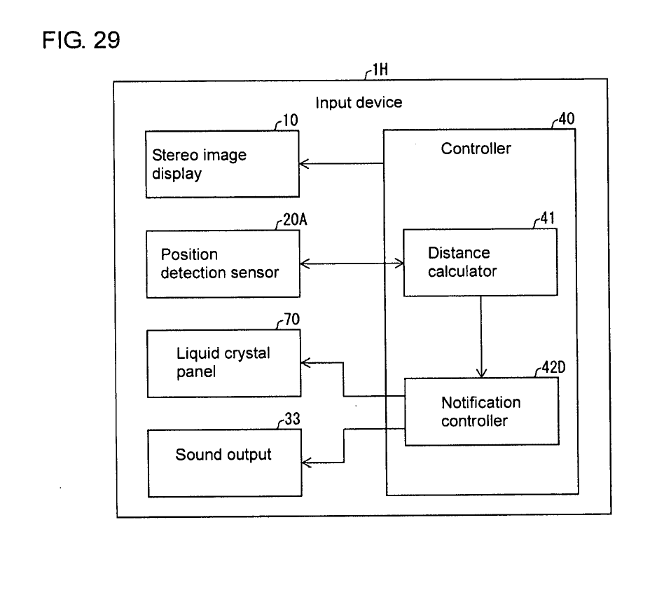

Another embodiment of the present invention will be described with reference to FIGS. 29 to 33. For convenience of explanation, the components having the same functions as the components described in the above embodiments are given the same reference numerals as those components and will not be described.

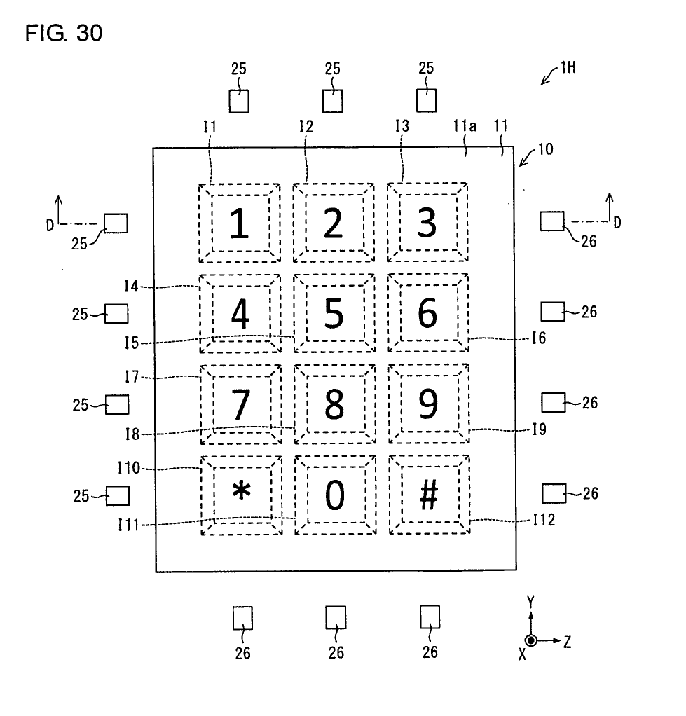

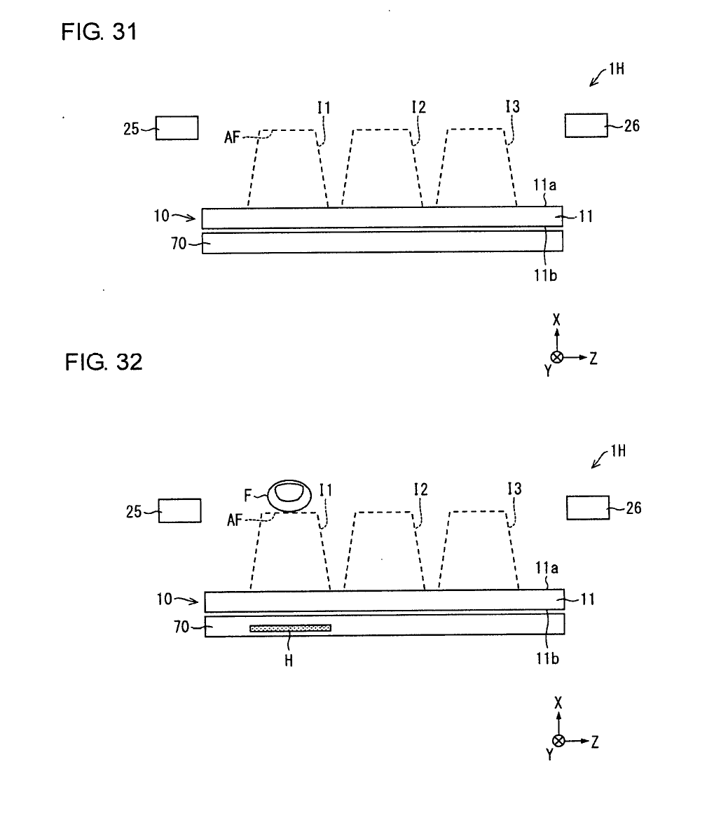

FIG. 29 is a block diagram of an input device 1H according to the present embodiment showing its main components. FIG. 30 is a plan view of the input device 1H. FIG. 31 is a schematic cross-sectional view of the input device 1H taken in the arrow direction of line A-A in FIG. 30.

As shown in FIGS. 29 to 31, the input device 1H according to the present embodiment includes a liquid crystal panel 70 (a light controller or a liquid crystal display) in place of the light emitter 31 and the diffuser 32 in the first embodiment. The input device 1H also includes a position detection sensor 20A (sensor) and a notification controller 42D in place of the position detection sensor 20 and the notification controller 42 in the first embodiment.

The liquid crystal panel 70 is located adjacent to the back surface 11b of the stereo image display 10, and displays an image using a liquid crystal. The liquid crystal panel 70 may be a known liquid crystal panel.

The position detection sensor 20A detects the position of the pointer F. As shown in FIG. 30, the position detection sensor 20A includes seven irradiators 25 and seven photoreceivers 26 corresponding to the respective irradiators 25. As shown in FIG. 31, the irradiators 25 and the photoreceivers 26 are arranged in front of the stereo image display 10, more specifically, in the plane including the front-and-rear direction (X-direction) including the front surfaces AF of the stereo images I. Three of the seven irradiators 25 are aligned in Z-direction, and three photoreceivers 26 corresponding to these three irradiators 25 are aligned in Z-direction across the stereo image display 10. The remaining four of the seven irradiators 25 are aligned in Y-direction, and four photoreceivers 26 corresponding to these four irradiators 25 are aligned in Y-direction across the stereo image display 10. In the position detection sensor 20A, light emitted from irradiators 25 is received by the opposite photoreceivers 26.

The position detection of the pointer F in the present embodiment will now be described. In the example described below, the pointer F has reached the front surface AF of the stereo image I1. In this case, the light emitted from the irradiator 25 located in the positive Y-direction of the stereo image I1 shown in FIG. 30 does not reach the corresponding photoreceiver 26. The position detection sensor 20A thus detects that the pointer F is located on the front surface AF of one of the stereo image I1, the stereo image I4, the stereo image I7, and the stereo image I10. Additionally, the light emitted from the irradiator 25 located in the negative Z-direction of the stereo image I1 shown in FIG. 30 does not reach the corresponding photoreceiver 26. The position detection sensor 20A thus detects that the pointer F is located on the front surface AF of one of the stereo image I1, the stereo image I2, and the stereo image I3. Under these two conditions, the position detection sensor 20A detects that the pointer F is located on the front surface AF of the stereo image I1.

The control performed by the notification controller 42D in the present embodiment will now be described. In the example described below, the pointer F has reached the front surface AF of the stereo image I1.

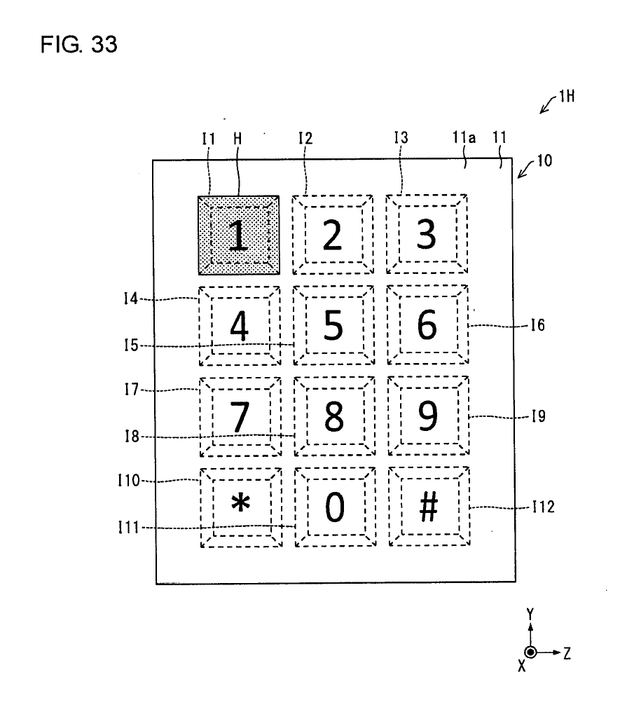

FIG. 32 shows the input device with the pointer F reaching the front surface AF of the stereo image I1. FIG. 33 is a plan view of the input device 1H in the state shown in FIG. 32.

In the present embodiment, as shown in FIG. 32, when the pointer F reaches the front surface AF of the stereo image I1, the notification controller 42D outputs an instruction to the liquid crystal panel 70 to display an image (e.g., a black rectangular image) in the area superposed on the stereo image I1 as viewed from the front (area H in FIG. 33). As a result, the back of the stereo image I1 turns black. The user can thus confirm that the input device 1H has received the operation on the input device 1H performed with the pointer F. This eliminates the user's worry that the input device 1H may not receive the input and provides the user with a sense of operation on the input device 1H.

### Sixth Embodiment

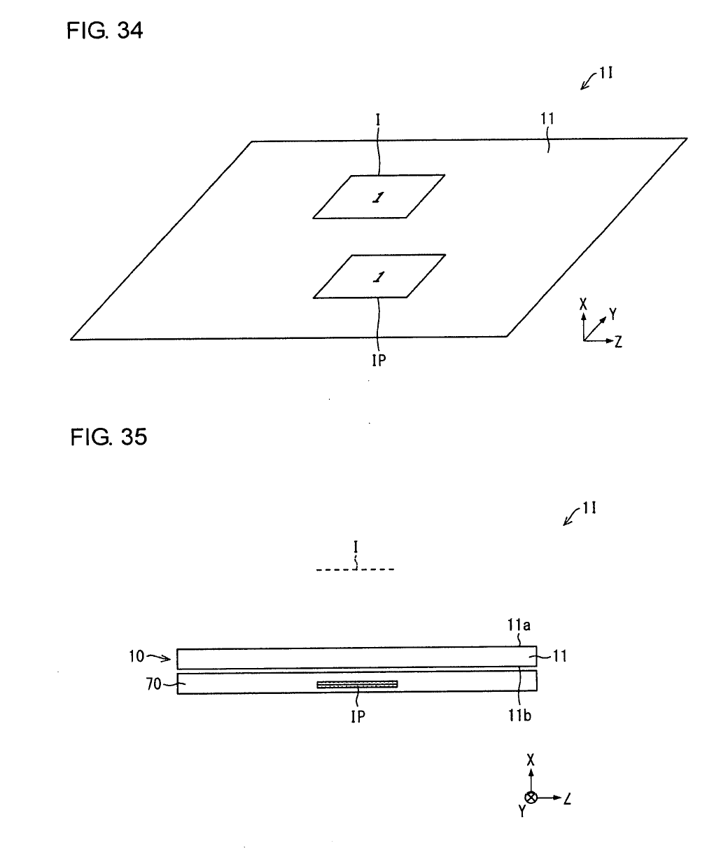

Another embodiment of the present invention will be described with reference to FIGS. 34 and 35. For convenience of explanation, the components having the same functions as the components described in the above embodiments are given the same reference numerals as those components and will not be described.

FIG. 34 is a perspective view of an input device 1I in the present embodiment displaying an image. FIG. 35 is a cross-sectional view of the input device 1I displaying the image.

The input device 1I in the present embodiment has the same configuration as the input device 1H in the fifth embodiment.

As shown in FIGS. 34 and 35, the input device 1I causes the stereo image display 10 to display a plane stereo image I. The stereo image I is formed parallel to the emission surface 11a of the light guide plate 11. The liquid crystal panel 70 in the input device 1I additionally displays a projected image IP of the stereo image I. More specifically, the liquid crystal panel 70 displays the projected image IP in the area superposed on the stereo image I as viewed from the front.

In this manner, the input device 1I in the present embodiment displays the stereo image I and the projected image IP corresponding to a projected shape of the stereo image I. The user recognizes the projected image IP as the shadow of the stereo image I. Thus, the user can easily have a sense of distance between the stereo image I and the light guide plate 11, and can feel a higher stereoscopic effect of the stereo image I.

In the present embodiment, the liquid crystal panel 70 displays the projected image IP. However, the input device according to one embodiment of the present invention is not limited to this structure. For example, the projected image IP may be displayed by the light emitter 50 described in the third and fourth embodiments.

In the present embodiment, the projected image IP has a projected shape of the stereo image I. However, the input device according to one embodiment of the present invention is not limited to this structure. The input device according to one embodiment of the present invention may simply display the outline of a stereo image I as a projected image IP or may display an image of the outline filled with black or another color as a projected image IP.

### Seventh Embodiment

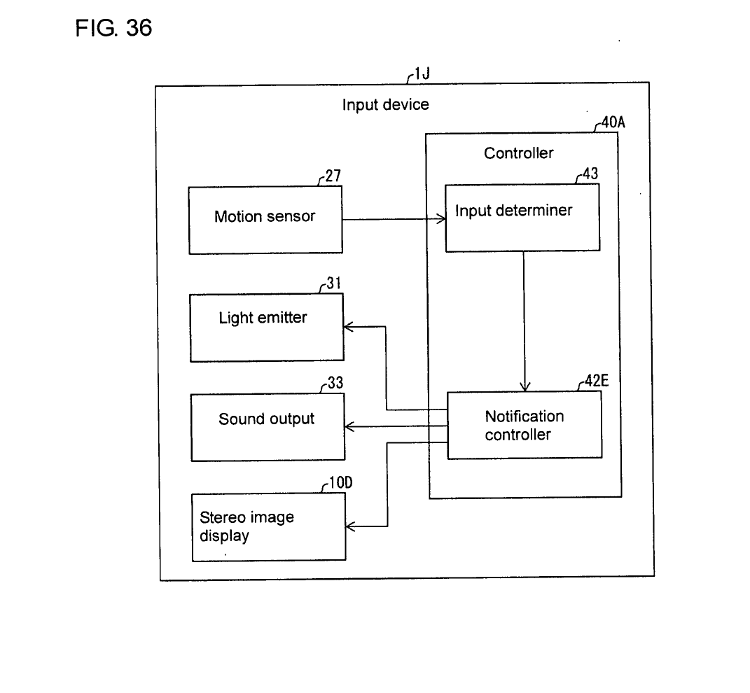

Another embodiment of the present invention will be described with reference to FIGS. 36 to 39C. For convenience of explanation, the components having the same functions as the components described in the above embodiments are given the same reference numerals as those components and will not be described.

FIG. 36 is a block diagram of an input device 1J showing its main components. As shown in FIG. 36, the input device 1J includes a motion sensor 27 (sensor), a stereo image display 10D, and a controller 40A in place of the stereo image display 10, the position detection sensor 20, and the controller 40 in the first embodiment.

The motion sensor 27 detects the position of the pointer F and the motion (movement) of the pointer F. The motion sensor 27, which may be any known motion sensor, will not be described in detail. The motion sensor 27 outputs the detected motion of the pointer F to an input determiner 43 (input sensor) (described later).

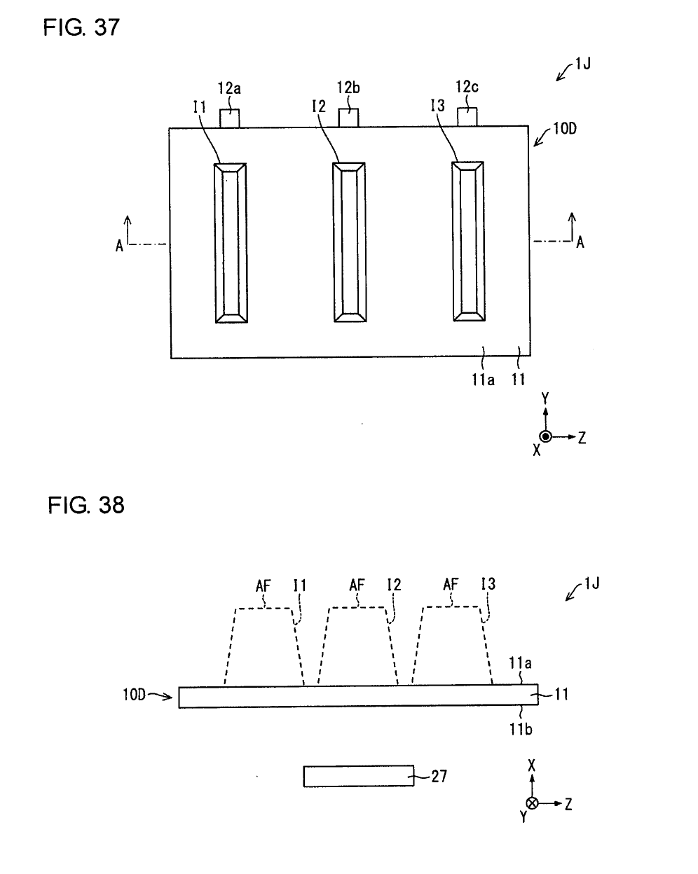

FIG. 37 shows the stereo image display 10D. FIG. 38 is a cross-sectional view taken in the arrow direction of line A-A in FIG. 37. As shown in FIGS. 37 and 38, the stereo image display 10D includes a light guide plate 11 and three light sources 12a to 12c. In the stereo image display 10D, the light emission of the light source 12a causes the stereo image I1 to appear, the light emission of the light source 12b causes the stereo image I2 to appear, and the light emission of the light source 12c causes the stereo image I3 to appear. The stereo images I1 to I3 are bar-shaped (rodlike).

The controller 40A includes the input determiner 43 and a notification controller 42E (image formation controller).

The input determiner 43 determines whether the user has performed an input to the input device 1J based on the motion of the pointer F output from the motion sensor 27. The determination will be described in detail later.

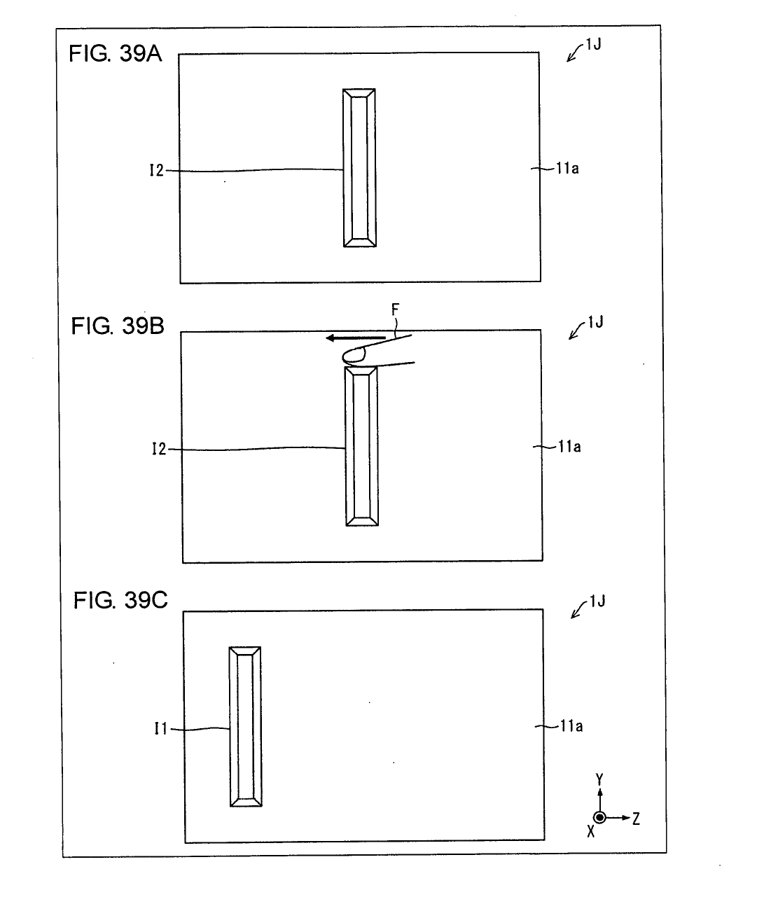

The operation of the input device 1J in the present embodiment will now be described with reference to FIGS. 39A to 39C. The input device 1J receives a slide operation from the user.

FIG. 39A is a diagram describing the operation of the input device 1J before receiving a user input. FIG. 39B is a diagram describing the operation of the input device 1J receiving a user input. FIG. 39C is a diagram describing the operation of the input device 1J after receiving the user input.

In the input device 1J before receiving an input from the user, the light source 12b of the light sources 12a to 12c emits light, and only the stereo image I2 is formed as shown in FIG. 39A.

The input determiner 43 then determines whether the user has performed a slide operation on the input device 1J. More specifically, the input determiner 43 determines whether the pointer F has reached the front surface AF of the stereo image I2 and then moved right or left (in Z-direction) based on the motion of the pointer F output from the motion sensor 27. In the example described below, the pointer F has reached the front surface AF of the stereo image I2 and then moved left (in the negative Z-direction) as shown in FIG. 39B. In response to this motion of the pointer F, the input determiner 43 determines that the user has performed an input to the input device 1J, and outputs the determination result to the notification controller 42E.

When receiving information indicating that the user has performed an input to the input device 1J from the input determiner 43, the notification controller 42E outputs an instruction to the stereo image display 10D to activate the light emission of the light source 12a and deactivate the light emission of the light source 12b. As a result, only the stereo image I1 is formed as shown in FIG. 39C.

In this manner, when the input determiner 43 in the input device 1J according to the present embodiment detects a user input operation performed by moving the pointer F on the front surface AF of the stereo image I, the notification controller 42E changes the imaging position of the stereo image I formed by the stereo image display 10D (more specifically, the light guide plate 11).

This structure allows the input device 1J to change the formation state of the stereo image I in accordance with the movement (motion) of the pointer F. More specifically, the input device 1J can receive various input instructions from the user and change the formation state of the stereo image I in response to the input instructions. The user can thus confirm that the input device 1J has received the operation on the input device 1J performed with the pointer F. This eliminates the user's worry that the input device 1J may not receive the input and provides the user with a sense of operation on the input device 1J.

### Fifth Modification

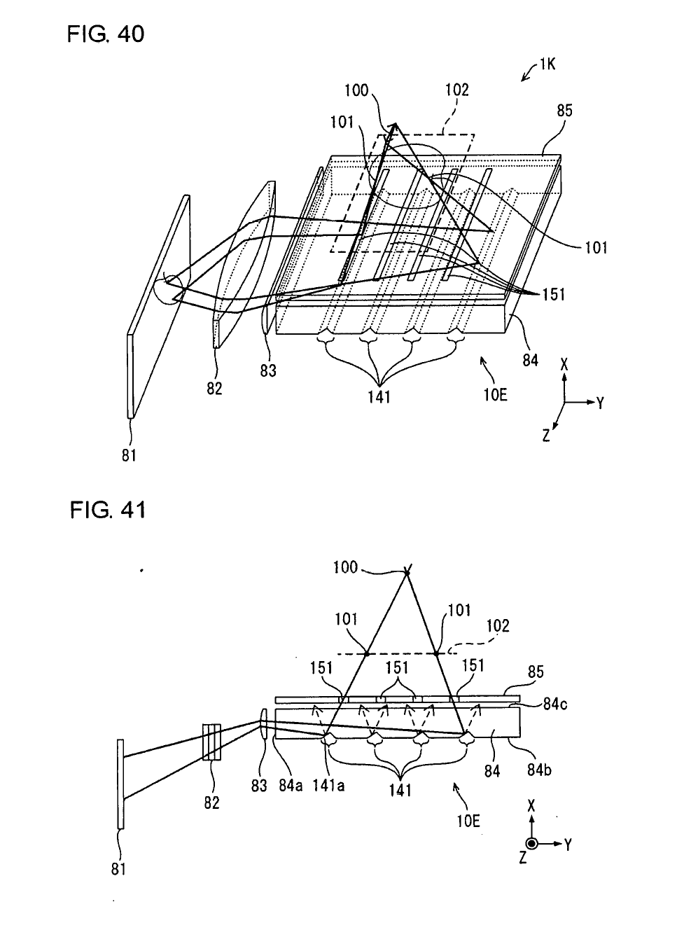

An input device 1K according to a modification of the input device 1J in the seventh embodiment will now be described with reference to FIGS. 40 and 41. For convenience of explanation, the components having the same functions as the components described in the above embodiments are given the same reference numerals as those components and will not be described.

FIG. 40 is a perspective view of the input device 1K. FIG. 41 is a cross-sectional view of a stereo image display 10E included in the input device 1K.

As shown in FIG. 40, the input device 1K includes the stereo image display 10E in place of the stereo image display 10D in the seventh embodiment. The input device 1J in the seventh embodiment and the input device 1K in the present modification are the same except that the stereo image display 10E forms a stereo image I. The formation of the stereo image I by the stereo image display 10E will now be described. FIGS. 40 and 41 do not show components other than the stereo image display 10E.

As shown in FIGS. 40 and 41, the stereo image display 10E includes an image display 81, an imaging lens 82, a collimator lens 83, a light guide plate 84 (first light guide plate), and a mask 85. The image display 81, the imaging lens 82, the collimator lens 83, and the light guide plate 84 are arranged in this order along Y-axis. The light guide plate 84 and the mask 85 are arranged in this order along X-axis.

The image display 81 causes its display area to display a two-dimensional image of the image projected in the air by the stereo image display 10E in response to an image signal from a controller (not shown). The image display 81 may be a common liquid crystal display that can output image light by displaying an image in the display area. In the illustrated example, the light guide plate 84 has an incident surface 84a facing the display area of the image display 81. The display area and the incident surface 84a are arranged parallel to the XZ plane. The light guide plate 84 has a back surface 84b on which prisms 141 (described later) are arranged and an emission surface 84c (light emission surface) for emitting light to the mask 85. The back surface 84b and the emission surface 84c are opposite to each other and parallel to the YZ plane. The mask 85 has a surface with slits 151 (described later), which is also parallel to the YZ plane. The display area of the image display 81 and the incident surface 84a of the light guide plate 84 may face each other, or the display area of the image display 81 may be inclined to the incident surface 84a.

The imaging lens 82 is located between the image display 81 and the incident surface 84a. The imaging lens 82 converges the image light output from the display area of the image display 81 in the YZ plane parallel to the length of the incident surface 84a and emits the converged light to the collimator lens 83. The imaging lens 82 may be any lens that can converge the image light. For example, the imaging lens 82 may be a bulk lens, a Fresnel lens, or a diffraction lens. The imaging lens 82 may also be a combination of lenses arranged along Z-axis.

The collimator lens 83 is located between the image display 81 and the incident surface 84a. The collimator lens 83 collimates the image light converged by the imaging lens 82 in the XY plane orthogonal to the length of the incident surface 84a. The collimator lens 83 emits the collimated image light to the incident surface 84a of the light guide plate 84. The collimator lens 83 may also be a bulk lens or a Fresnel lens like the imaging lens 82. The imaging lens 82 and the collimator lens 83 may be arranged in the reverse order. The functions of the imaging lens 82 and the collimator lens 83 may be implemented by one lens or a combination of multiple lenses. More specifically, the imaging lens 82 and the collimator lens 83 may be any combination that can converge, in the YZ plane, the image light output by the image display 81 from the display area and collimate the image light in the XY plane.

The light guide plate 84 is a transparent member, and its incident surface 84a receives the image light collimated in the collimator lens 83, and its emission surface 84c emits the light. In the illustrated example, the light guide plate 84 is a plate-like rectangular prism, and the incident surface 84a is a surface facing the collimator lens 83 and parallel to the XZ plane. The back surface 84b is a surface parallel to the YZ plane and located in the negative X-direction, whereas the emission surface 84c is a surface parallel to the YZ plane and opposite to the back surface 84b. The light guide plate 84 includes the multiple prisms (emission structures or optical path changers) 141.

The multiple prisms 141 reflect the image light incident through the incident surface 84a of the light guide plate 84. The prisms 141 are arranged on the back surface 84b of the light guide plate 84 and protrude from the back surface 84b toward the emission surface 84c. For the image light traveling in Y-direction, the prisms 141 are, for example, substantially triangular grooves arranged at predetermined intervals (e.g., 1 mm) in Y-direction and having a predetermined width (e.g., 10 μm) in Y-direction. Each prism 141 has optical faces, with its face nearer the incident surface 84a in the image light guided direction (positive Y-direction) being a reflective surface 141a. In the illustrated example, the prisms 141 are formed in the back surface 84b in parallel to Z-axis. The image light incident through the incident surface 84a and traveling in Y-direction is reflected by the reflective surfaces 141a of the multiple prisms 141 formed parallel to Z-axis orthogonal to Y-axis. The display area of the image display 81 emits image light from positions different in X-direction orthogonal to the length of the incident surface 84a, and each of the prisms 141 causes the image light to travel toward a predetermined viewpoint 100 from the emission surface 84c of the light guide plate 84. The reflective surface 141a will be described in detail later.

The mask 85 is formed from a material opaque to visible light and has multiple slits 151. The mask 85 allows passage of light traveling toward imaging points 101 in a plane 102 through the slits 151, selectively from the light emitted through the emission surface 84c of the light guide plate 84.

The multiple slits 151 allow passage of the light traveling toward the imaging points 101 in the plane 102 through the slits 151, selectively from the light emitted through the emission surface 84c of the light guide plate 84. In the illustrated example, the slits 151 extend parallel to Z-axis. Each slit 151 corresponds to one of the prisms 141.

The stereo image display 10D with this structure allows an image appearing on the image display 81 to be formed and projected on the virtual plane 102 external to the stereo image display 10D. More specifically, the image light is first emitted from the display area of the image display 81 and passes through the imaging lens 82 and the collimator lens 83. The image light then enters the incident surface 84a, which is an end face of the light guide plate 84. The image light incident on the light guide plate 84 travels through the light guide plate 84 and reaches the prisms 141 on the back surface 84b of the light guide plate 84. The image light reaching the prisms 141 is then reflected by the reflective surfaces 141a of the prisms 141. The reflected image light travels in the positive X-direction and is emitted through the emission surface 84c of the light guide plate 84 parallel to the YZ plane. The image light emitted through the emission surface 84c partially passes through the slits 151 in the mask 85 to form an image at the imaging points 101 an the plane 102. In other words, the image light emitted from individual points in the display area of the image display 81 converges in the YZ plane and is collimated in the XY plane. The resulting image light is projected on the imaging points 101 on the plane 102. The stereo image display 10D can perform this processing for all points in the display area to project the image output from the display area of the image display 81 onto the plane 102. As a result, the user can visually identify the image projected in the air when viewing the virtual plane 102 from the viewpoint 100. Although the plane 102 is a virtual plane on which a projected image is formed, a screen may be used to serve as the plane 102 to improve visibility.

In this manner, the stereo image display 10E allows an image appearing on the image display 81 to form a stereo image I. When the input determiner 43 detects a user input operation performed by moving the pointer F on the front surface AF of the stereo image I, the notification controller 42E can change the formation state (e.g., the position, the size, the amount of light, and the color) of the stereo image I formed by the stereo image display 10E (more specifically, the light guide plate 84). The user can thus confirm that the input device 1K has received the operation on the input device 1K performed with the pointer F. This eliminates the user's worry that the input device 1K may not receive the input and provides the user with a sense of operation on the input device 1K.

In the stereo image display 10E according to the present embodiment, image light passes through the slits 151 in the mask 85 selectively from the image light emitted through the emission surface 84c to form an image. However, any structure with no mask 85 or no slit 151 may allow image light to form on the imaging points 101 on the virtual plane 102.

For example, the reflective surface of each prism 141 and the back surface 84b may form a larger angle at a larger distance from the incident surface 84a. This structure can allow image light to form on the imaging points 101 on the virtual plane 102. The angle is set to allow the prism 141 farthest from the incident surface 84a to totally reflect light from the image display 81.

At this angle setting, light emitted at a position more rearward from the back surface 84b in X-direction in the display area of the image display 81 (in the negative X-direction) toward a predetermined viewpoint is reflected by a prism 141 farther from the incident surface 84a. However, the stereo image display may have any other structure that defines the correspondence between one position in X-direction in the display area of the image display 81 and one prism 141. Light reflected by a prism 141 farther from the incident surface 84a travels in a direction more inclined toward the incident surface 84a, whereas light reflected by a prism 141 nearer the incident surface 84a travels in a direction more inclined away from the incident surface 84a. Thus, the light from the image display 81 can be emitted toward a particular viewpoint without the mask 85. In Z-direction, the light emitted through the light guide plate 84 is focused on the image projected plane and diffuses as the light travels away from the plane. This causes a parallax in Z-direction, which enables a viewer to view a projected stereo image with both eyes aligned in Z-direction.

This structure does not shield light reflected by each prism 141 and traveling to the viewpoint. The viewer can thus view the image appearing on the image display 81 and projected in the air also when moving the viewpoint along Y-axis. However, the angle formed by the light beam directed from each prism 141 to the viewpoint and the reflective surface of the prism 141 changes depending on the viewpoint position in Y-direction, and the position of the point on the image display 81 corresponding to the light beam also changes accordingly. In this example, the prisms 141 focus the light from each point on the image display 81 also in Y-direction to a certain degree. Thus, the viewer can also view a stereo image with both eyes aligned along Y-axis.

This structure includes no mask 85 and reduces the loss of light. The stereo image display can thus project a brighter image in the air. Without the mask, the stereo image display allows the viewer to visually identify both an object (not shown) behind the light guide plate 84 and the projected image.

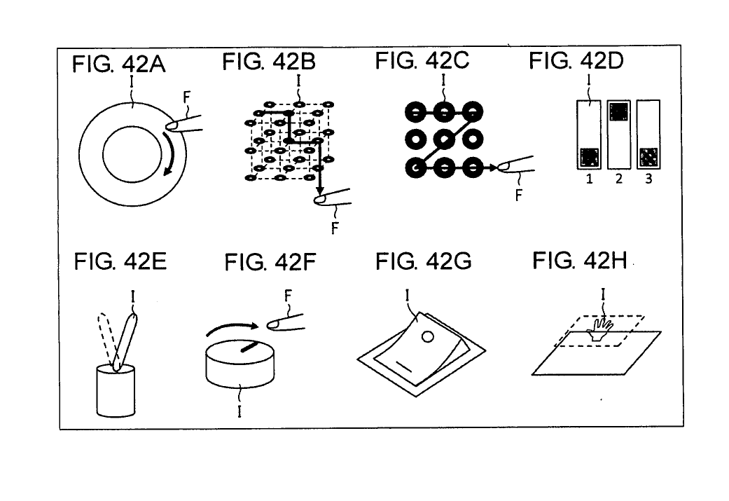

Example uses of the input device 1J in the seventh embodiment and the input device 1K in the fifth modification will now be described with reference to FIGS. 42A to 42H. FIGS. 42A to 42H are diagrams describing uses of the input device 1J or the input device 1K.

As shown in FIG. 42A, the input device 1J or the input device 1K may form an annular stereo image I. When receiving information indicating that the pointer F has moved along the ring of the stereo image I from the input determiner 43, the notification controller 42E changes the formation state of the stereo image I. For example, the notification controller 42E may change the color or size of the ring.

As shown in FIG. 42B, the input device 1J or the input device 1K may display multiple dots arranged three-dimensionally. In accordance with the movement of the pointer F detected by the motion sensor 27, the notification controller 42E displays a stereo image I including the locus of the pointer F. FIG. 42B shows the example use for a space lock pattern. As shown in FIG. 42C, multiple dots may also be displayed in a single plane.

As shown in FIGS. 42D to 42G, the input device 1J or the input device 1K may be used as a switch. FIG. 42D is a schematic view of a stereo image I displayed as dual in-line package (DIP) switches arranged in parallel. FIG. 42E is a schematic view of a stereo image I displayed as a toggle switch. FIG. 42F is a schematic view of a stereo image I displayed as a rotary switch. FIG. 42G is a schematic view of a stereo image I displayed as a rocker switch. When the motion sensor 27 detects the pointer F performing an input to the stereo switch image I, the input device 1J or the input device 1K may change the formation state of the stereo image I depending on the operation, and performs an output corresponding to the operation to an external device.

As shown in FIG. 42H, when the input device 1J or the input device 1K receives an input to the stereo image I performed with the pointer F, the input device may form a stereo image I indicating the position at which the input has been received. Applications

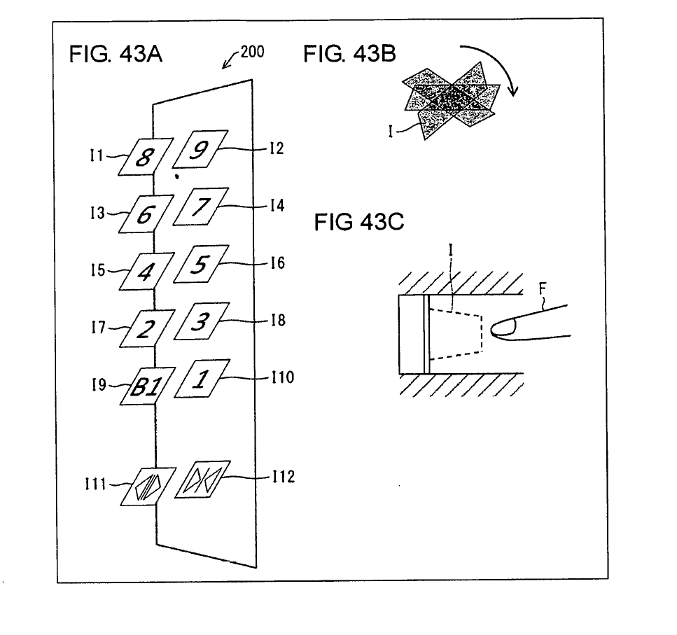

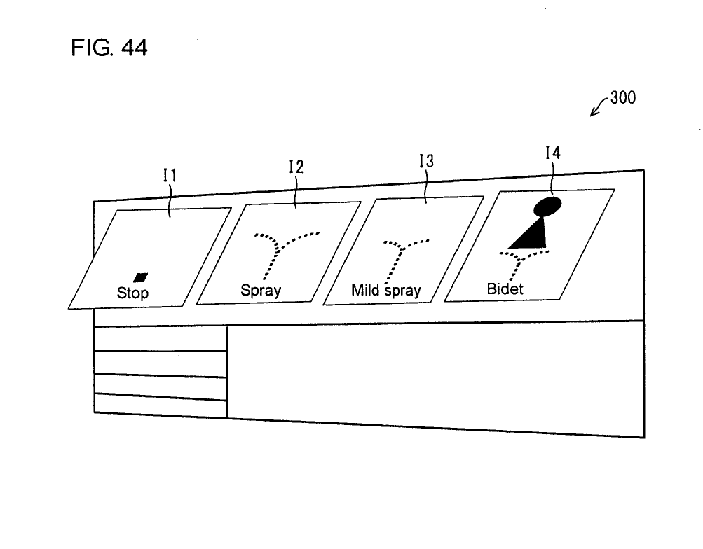

Example uses of the input devices described in the embodiments and the modifications will now be described with reference to FIGS. 43A to 44.

FIGS. 43A to 43C show the input device according to one embodiment of the present invention used for an input section for an elevator. As shown in FIG. 43A, the input device according to one embodiment of the present invention may be used as an input section 200 for an elevator. More specifically, the input section 200 displays stereo images I1 to I12. The stereo images I1 to I12 are representations for receiving a user input that selects an elevator destination (floor number) (stereo images I1 to I10) or representations for receiving an instruction to open or close the elevator door (stereo images I11 and I12). When the input section 200 receives a user input on one of the stereo images I, the input section 200 changes the formation state of the stereo image I (e.g., changes the color of the stereo image I) and outputs an instruction corresponding to the input to the elevator controller. The input section 200 may display the stereo images I only when a person approaches the input section 200. The input section 200 may also be embedded in the elevator wall.

For an elevator crowded with passengers for example, the body of a user may accidentally overlap the imaging position of the stereo image I, and the input section 200 for the elevator may receive an unintended user input. The input section 200 may thus receive a user input only when the motion sensor 27 receives an operation for turning the stereo image I as shown in FIG. 43B. A turning operation is performed when intended by a user. This prevents the input section 200 from receiving an unintended user input. In some embodiments, as shown in FIG. 43C, a stereo image I may be displayed in a recess in an inner wall of the elevator. An input to this stereo image I is allowed only when the pointer F is inserted into the recess. This prevents the input section 200 from receiving an unintended user input.

FIG. 44 shows the input device according to one embodiment of the present invention to be used in an input section for a warm-water washing toilet seat. As shown in FIG. 44, the input device according to one embodiment of the present invention may be used in an input section 300 (operation panel) for a warm-water washing toilet seat. The input section 300 displays stereo images I1 to I4, which are representations for receiving an instruction to activate or stop washing performed by the warm-water washing toilet seat. When receiving a user input on one of the stereo images I, the input section 300 changes the formation state of the stereo image I (e.g., changes the color of the stereo image I) and outputs an instruction corresponding to the input to the warm-water washing toilet seat controller. Many users may avoid directly touching the operation panel for the warm-water washing toilet seat for sanitary reasons. The input section 300 is operable by users without directly (physically) touching the input section 300. This allows users to perform an operation without caring about sanitation. The input device according to the embodiment of the present invention may be used in other apparatuses that users may avoid touching directly for sanitary reasons. For example, the input device according to the embodiment of the present invention may be used for a ticket dispenser installed in a hospital and an operation section for an autodoor touched by unspecified users. Additionally, a ticket dispenser installed in a hospital may provide multiple choices among, for example, different departments of surgery and internal medicine. The input device according to the embodiment may display stereo images I corresponding to such multiple choices. The input device according to the embodiment of the present invention may also be used for a cash register or a meal ticket machine installed in a restaurant.

The input device according to one embodiment of the present invention may include a stereo image display that displays a stereo image I by parallax fusion using light emitted through a transparent light guide plate. The input device according to another embodiment of the present invention may include a stereo image display including a double-sided reflector array in which multiple sets of mirrors orthogonal to each other are arranged on an optocoupler plane. The input device according to still another embodiment of the present invention may include a stereo image display that uses the Pepper's ghost technique with a semitransparent mirror.

### Implementations Using Software

The control blocks (in particular, the controller 40 and the controller 40A) in the input devices 1 and 1A to 1K may be achieved using a logic circuit (hardware) included in an integrated circuit (IC chip), or using software implemented by a central processing unit (CPU).

When software is used, the input devices 1 and 1A to 1K each include a CPU for executing instructions of programs corresponding to the software that achieves each function, a read-only memory (ROM) or a storage (collectively referred to as a recording medium) on which the programs and data is recorded in a computer-readable (or CPU-readable) manner, and a random access memory (RAM) in which the programs can run. The computer (or CPU) reads the programs from the recording medium and executes them to achieve the aspects of the present invention. The recording medium may be a non-transitory tangible medium such as a tape, a disk, a card, a semiconductor memory, or a programmable logic circuit. The programs may be provided to the computer through any transmission medium (a communication network or a broadcast wave) that can transmit the programs. One or more embodiments of the present invention may be implemented using the programs electronically transmitted in the form of data signals on a carrier wave.

The embodiments disclosed herein should not be construed to be restrictive but may be modified within the spirit and scope of the claimed invention. The technical features disclosed in different embodiments may be combined in other embodiments within the technical scope of the invention. Accordingly, the scope of the invention should be limited only by the claims attached.

### REFERENCE SIGNS LIST

1, 1A to 1K input device
11, 15, 84 light guide plate (first light guide plate)
11a, 14a, 15a, 84c emission surface (light emission surface)
12, 12a to 12c, 52, 52a to 52I light source
13, 13a, 13b, 13c, 16 optical path changer
14A to 14D light guide plate (partial light guide plate)
20, 20A position detection sensor (sensor)
27 motion sensor (sensor)
42, 42A to 42E notification controller (input sensor, light emitter)
43 input determiner (input sensor)
31 light emitter
33 sound output (sound output device)
34 ultrasound generator (tactile stimulator)
35 reference (imaging plane presenter)
35a front surface (flat surface portion)
50 light emitter (light controller or second light guide plate)
51b front surface (light emission surface)
60 liquid crystal display (light controller or liquid crystal display)
70 liquid crystal panel (light controller or liquid crystal display)
I, I1 to I12 stereo image (image)
IP projected image

1. An input device, comprising:
a first light guide plate that guides light received from a light source and emits the light through a light emission surface to form an image in a space;
a sensor that detects an object in a space including an imaging position at which the image is formed;
an input sensor that senses a user input in response to detection of the object by the sensor; and
a notification controller that changes a method of notification to the user in accordance with a distance between the imaging position and the object, the distance being detected by the sensor.

2. The input device according to claim 1, wherein
the notification controller uses a different method of notification for when the object is located in a nearby space that is a predetermined range from the imaging position and for when the object is located at the imaging position.

3. The input device according to claim 2, wherein
the image comprises a plurality of images formed at a plurality of positions, and the nearby space is defined at an imaging position of each of the plurality of images, and
when the object is detected in the nearby space, the notification controller provides a notification identifying the image formed at the position included in the nearby space.

4. The input device according to claim 1, wherein
the notification controller changes a display state of the image to change the method of notification.

5. The input device according to claim 4, further comprising:
a light controller located adjacent to the light emission surface of the first light guide plate or located opposite to the light emission surface, wherein
the light controller changes a light emission state or a light transmission state depending on a position,
the image comprises a plurality of images formed at a plurality of positions, and
the notification controller changes a light emission state or a light transmission state in the light controller depending on the imaging position of each of the plurality of images to change the method of notification.

6. The input device according to claim 5, wherein
the light controller is any one selected from a group comprising:
a light emitter that controls light emission of a plurality of light emitters arranged at a plurality of positions,
a second light guide plate that guides light received from a light source, emits the light through a light emission surface, and controls a position for emitting light through the light emission surface, and
a liquid crystal display that controls light emission or light transmission depending on a position.

7. The input device according to claim 1, further comprising:
a sound output device that outputs a sound,
wherein the notification controller changes an output from the sound output device to change the method of notification.

8. The input device according to claim 1, further comprising:
a tactile stimulator that remotely stimulates a tactile sense of a human body located in a space including the imaging position,
wherein the notification controller changes an output from the tactile stimulator to change the method of notification.

9. The input device according to claim 1, wherein
the first light guide plate comprises a plurality of partial light guide plates,
each of the plurality of partial light guide plates includes a light-guiding area between an incident surface receiving light from the light source and a light-emitting area on the light emission surface, and
at least one of the partial light guide plates is adjacent to the light emission surface of another partial light guide plate and at least partially overlap in the light-guiding area of the other partial light guide plate.

10. The input device according to claim 1, wherein
the image comprises a plurality of images formed at a plurality of positions, and one or more of the plurality of images each correspond to a number or a character, and
the input device outputs input character information in accordance with a sensing result from the input sensor.

11. The input device according to claim 1, wherein
the first light guide plate includes a plurality of optical path changers that redirects light guided within the first light guide plate to be emitted through the light emission surface, and
the light redirected by the optical path changers and emitted through the light emission surface converges at a predetermined position in a space to form an image.

12. An input device, comprising:
a first light guide plate that guides light received from a light source and emits the light through a light emission surface to form an image in a screenless space;
a sensor that detects an object in a space including an imaging position at which the image is formed;
an input sensor that senses a user input in response to detection of the object by the sensor;
a light controller located adjacent to the light emission surface of the first light guide plate or located opposite to the light emission surface, the light controller that changes a light emission state or a light transmission state depending on a position; and
a notification controller that controls the light controller in response to a detection result from the sensor.

13. The input device according to claim 12, wherein
the light controller is any one selected from a group comprising:
a light emitter that controls light emission of a plurality of light emitters arranged at a plurality of positions;
a second light guide plate that guides light received from a light source, emits the light through a light emission surface, and controls a position for emitting light through the light emission surface; and
a liquid crystal display that controls light emission or light transmission depending on a position.

14. An input device, comprising:
a first light guide plate that guides light received from a light source and emits the light through a light emission surface to form an image in a space;
a sensor that detects an object in a space including an imaging position at which the image is formed;
an input sensor that senses a user input in response to detection of the object by the sensor; and
an image formation controller that changes a formation state of the image formed by the first light guide plate when the input sensor detects a user input performed by moving the object within an image formation area including the imaging position of the image.

15. An input device, comprising:
a first light guide plate that guides light received from a light source and emits the light through a light emission surface to form an image in a space;
a sensor that detects an object in a space including an imaging position at which the image is formed;
an input sensor that senses a user input in response to detection of the object by the sensor; and
an imaging plane presenter having a flat surface portion in an imaging plane including an image formation area including the imaging position of the image, the flat surface portion being at a position different from the image formation area.

16. An input device, comprising:
a first light guide plate that guides light received from a light source and emits the light through a light emission surface to form an image in a space;
a sensor that detects an object in a space including an imaging position at which the image is formed;
an input sensor that senses a user input in response to detection of the object by the sensor; and
a light controller located adjacent to the light emission surface of the first light guide plate or located opposite to the light emission surface that changes a light emission state or a light transmission state depending on a position to display a projected image corresponding to a projected shape of the image formed by the first light guide plate.
